(19) United States
(12) Patent Application Publication
(10) Pub. No.: US 2026/0134245 A1
(43) Pub. Date: May 14, 2026

(54) COLOR MANAGEMENT METHOD, COLOR MANAGEMENT APPARATUS AND STORAGE MEDIUM

(71) Applicant: Konica Minolta, Inc., Tokyo (JP)

(72) Inventors: Hiroyuki OOYAMA, Tokyo (JP); Masatsugu KOUGUCHI, Tokyo (JP); Kazuma MARUYAMA, Tokyo (JP); Tomohiro OZAWA, Tokyo (JP)

(21) Appl. No.: 19/382,855

(22) Filed: Nov. 7, 2025

(30) Foreign Application Priority Data
Nov. 14, 2024 (JP) 2024-199214

(51) Int. Cl. G06K 15/00; G06K 15/02

(52) U.S. Cl. CPC G06K 15/407; G06K 15/1823

(57) ABSTRACT

A color management method is performed by a color management apparatus that performs color management based on data of a sheet subjected to printing and read by a reader including a colorimeter and a scanner. The method includes, in response to receiving a setting of a first operation mode in which the colorimeter moves a first width in a sheet width direction and reads all or at least one of patches arranged in the sheet width direction, performing the color management based on the data read in the first operation mode, and in response to receiving a setting of a second operation mode in which the colorimeter stops or moves a second width smaller than the first width in the sheet width direction and the scanner reads all or at least one of the patches, performing the color management based on the data read in the second operation mode.

### CROSS-REFERENCE TO RELATED APPLICATIONS

The entire disclosure of Japanese Patent Application No. 2024-199214 filed on November 14, 2024, is incorporated herein by reference in its entirety.

### BACKGROUND OF THE INVENTION

### TECHNICAL FIELD

The present disclosure relates to a color management method, a color management apparatus and a storage medium.

### DESCRIPTION OF RELATED ART

There is an image forming apparatus that reads a sheet on which a chart is printed by a reading device (inline reading device) set on a conveyance path of the sheet and performs color management. In such an image forming apparatus, a series of processes such as printing of a chart, color measurement of the chart, and color management based on color measurement data can be automated. For example, when a user performs a predetermined operation, a series of processes is executed. Therefore, color management of the image forming apparatus can be performed even by an operator who has little knowledge or experience about work called "color matching" such as color verification and color correction.

Japanese Unexamined Patent Publication No. 2024-85279 describes a color measurement control apparatus including, as inline reading devices, both a scanner (line type CCD sensor or the like) and an optical colorimeter movable in a sheet width direction (CD direction) orthogonal to a sheet conveyance direction. The color measurement control apparatus executes color measurement with the colorimeter when there is a color variation equal to or greater than a predetermined value in reading with the scanner. According to this technology, in a case where the color variation in reading with the scanner is less than the predetermined value, the color measurement with the colorimeter is not performed, and thus it is possible to suppress a decrease in productivity.

### SUMMARY OF THE INVENTION

However, since the scanner calculates colorimetric values (L*a*b* values, XYZ values, and the like), from read data (RGB values), the accuracy of the colorimetric values is low. That is, the data read by the scanner itself includes a variation element. In other words, even if there is no color variation in reading with the scanner, the actual color may vary. For example, in color measurement with a scanner, a plurality of patches is collectively subjected to color measurement. Therefore, read data (RGB values) may vary due to the influence of reflected light by an adjacent patch or the like, and the accuracy may significantly decrease. In the technology described in Japanese Unexamined Patent Publication No. 2024-85279, there is a problem that in a case where it is determined that there is no color variation in reading with the scanner and there is no need for color measurement with the colorimeter, color matching may be performed based on incorrect read data.

The present disclosure has been made in view of the above-described problem in the above-described conventional technology, and an object of the present disclosure is to allow an operator to consciously set one of operation modes different in proportion of data read by an colorimeter and a scanner, with respect to a reading section that is used in color management.

To achieve at least one of the abovementioned objects, according to an aspect of the present disclosure, a color management method reflecting one aspect of the present disclosure is performed by a color management apparatus that performs color management based on data of a sheet on which printing has been performed by an image former and that has been read by a reader including a colorimeter and a scanner and disposed on a conveyance path of the sheet, the color management method including:

in response to receiving a setting of a first operation mode in which the colorimeter moves a first width in a sheet width direction and reads all or at least one of a plurality of patches arranged in the sheet width direction, performing the color management based on the data read in the first operation mode; and

in response to receiving a setting of a second operation mode in which the colorimeter stops or moves a second width smaller than the first width in the sheet width direction and the scanner reads all or at least one of the plurality of patches arranged in the sheet width direction, performing the color management based on the data read in the second operation mode.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present disclosure, wherein:

FIG. 1 is a configuration diagram of a color management system according to a first embodiment of the present disclosure;

FIG. 2 is a diagram illustrating a hardware configuration of an image forming apparatus;

FIG. 3 is a diagram illustrating an appearance configuration of the image forming apparatus;

FIG. 4 is a diagram schematically showing a positional relationship between an inline reading section and a chart;

FIG. 5 is a diagram illustrating a hardware configuration of a PC;

FIG. 6 is a diagram illustrating a hardware configuration of a printer controller;

FIG. 7 is a diagram illustrating a hardware configuration of a color management apparatus;

FIG. 8 is a diagram illustrating an example of a data structure of a printer information table;

FIG. 9 is a diagram illustrating an example of a data structure of a color management dataset table;

FIG. 10 is a diagram illustrating an example of a data structure of a color management preset table;

FIG. 11 is an example of a chart in a case where a mode A is set;

FIG. 12 is an example of a chart in a case where a mode B is set;

FIG. 13 is an example of a chart in a case where a mode C is set;

FIG. 14 is an example of a chart in a case where a mode D is set;

FIG. 15 is an example of a chart in a case where a mode E is set;

FIG. 16 is a flowchart illustrating a color management execution process;

FIG. 17 is an example of a color management dataset selection screen;

FIG. 18 is an example of a color measurement setting screen;

FIG. 19 is a flowchart illustrating a first additional process in a first modification example of the first embodiment;

FIG. 20 is a flowchart illustrating a second additional process in a second modification example of the first embodiment;

FIG. 21 is a flowchart illustrating a first color management dataset registration process in a second embodiment;

FIG. 22 is an example of a color management dataset registration screen;

FIG. 23 is a flowchart illustrating a second color management dataset registration process in a third embodiment;

FIG. 24 is a flowchart illustrating a first color management preset registration process in a fourth embodiment; and

FIG. 25 is a flowchart illustrating a second color management preset registration process in a fifth embodiment.

### DETAILED DESCRIPTION

Hereinafter, one or more embodiments of the present disclosure will be described with reference to the drawings. However, the scope of the present disclosure is not limited to the disclosed embodiments. Advantages and features provided by the embodiments will be understood from the following detailed description and the drawings. However, the scope of the present disclosure is not limited to the embodiments disclosed below or examples illustrated in the drawings.

### First Embodiment

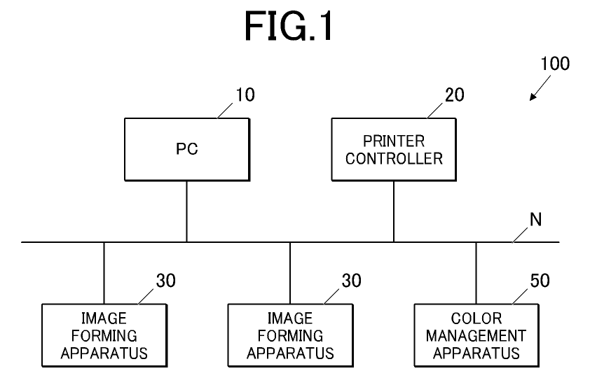

FIG. 1 shows a configuration of a color management system 100 according to a first embodiment. The color management system 100 includes a personal computer (PC) 10, a printer controller 20, a plurality of image forming apparatuses 30, and a color management apparatus 50. The apparatuses constituting the color management system 100 are connected via a communication network N such as a LAN (Local Area Network) so as to be able to perform data communication. Note that the number of apparatuses of each apparatus is not particularly limited. The color management system 100 is used, for example, in a print shop or the like that provides printed materials to customers.

A printer driver program 121 (see FIG. 5) is installed in the PC 10. The PC 10 issues a print instruction to the printer controller 20 or the image forming apparatus(es) 30 by a printer driver. Specifically, the PC 10 generates print data described in a page description language (PDL) interpretable by the printer controller 20 in response to a user operation. Further, the PC 10 may issue a print instruction to the printer controller 20 or the image forming apparatus 30 about data such as PDF data by using a specific application without using the printer driver.

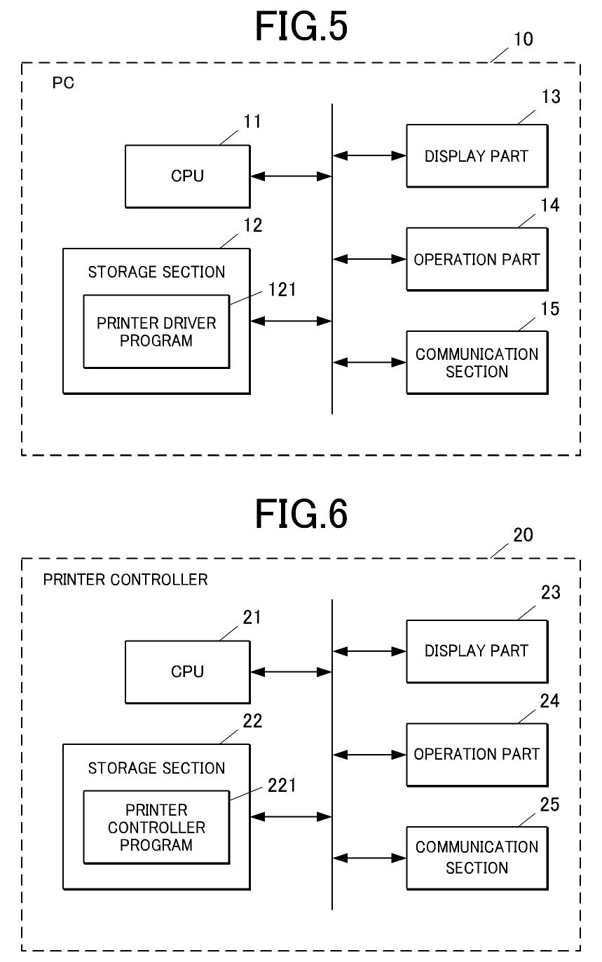

A printer controller program 221 (see FIG. 6) is installed in the printer controller 20. The printer controller 20 receives print data from the PC 10. Further, the printer controller 20 receives chart data from the color management apparatus 50. The printer controller 20 performs raster image processing (RIP) on the print data or the chart data to generate image data for printing (raster data). Further, the printer controller 20 performs image processing such as color conversion or screening on the image data for printing. The printer controller 20 transmits image data (raster data) after the image processing to the image forming apparatus 30.

The printer controller 20 may be built in the image forming apparatus 30. The printer controller 20 and the image forming apparatuses 30 may be connected to each other via a dedicated line such as a PCI connection.

Each image forming apparatus 30 forms an image on a sheet based on raster data (image data in a bitmap format) received from the printer controller 20. Examples of the sheet include a printing sheet and various films. Examples of the type of sheet include plain paper, high-quality paper, gloss coated paper, and matt coated paper.

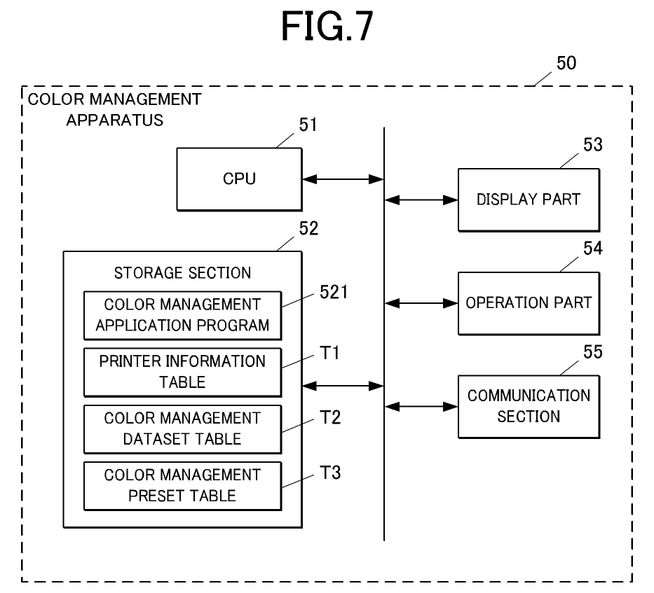

A color management application program 521 (see FIG. 7) for performing color management of the image forming apparatuses 30 is installed in the color management apparatus 50. The color management apparatus 50 performs color verification, color profile creation, color correction, history management, and the like in the image forming apparatuses 30.

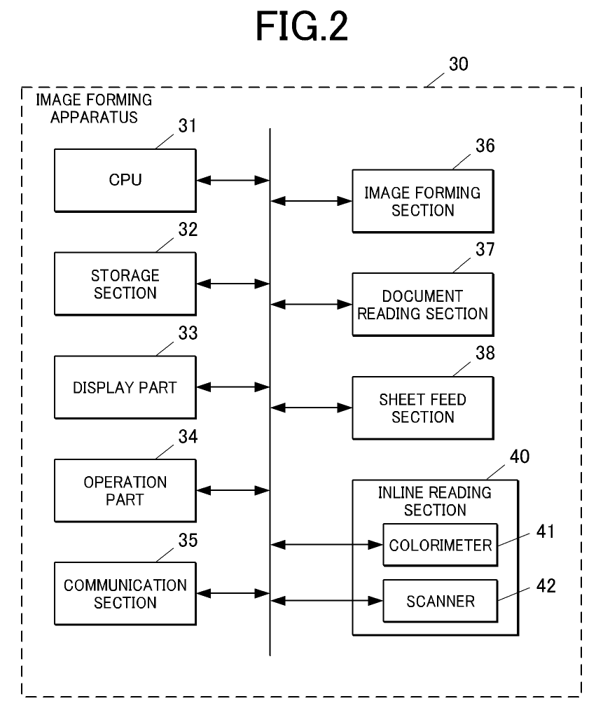

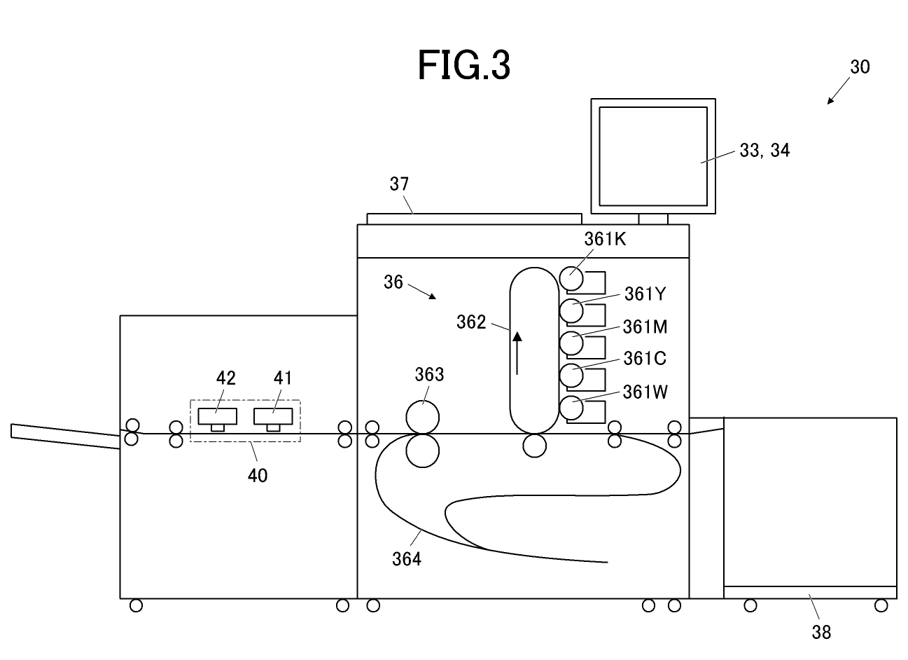

FIG. 2 illustrates a hardware configuration of each image forming apparatus 30. FIG. 3 illustrates an external configuration of the image forming apparatus 30. The image forming apparatus 30 is capable of image formation with toner in white (W), which is a spot color, in addition to toner in four colors of cyan (C), magenta (M), yellow (Y), and black (K).

The image forming apparatus 30 includes a central processing unit (CPU) 31, a storage section 32, a display part 33, an operation part 34, a communication section 35, an image forming section 36 (image former), a document reading section 37, a sheet feed section 38, and an inline reading section 40 (reader).

The CPU 31 comprehensively controls processing operation of each component of the image forming apparatus 30. The CPU 31 reads various process programs stored in the storage section 32 and performs various processes in cooperation with the programs.

The storage section 32 includes a hard disk drive (HDD), a solid state drive (SSD), and a nonvolatile memory. The storage section 32 stores various process programs, data related to various processes, and the like. For example, the storage section 32 stores sheet information related to the image forming apparatus 30 and so forth. Further, the storage section 32 stores a target profile, a printer profile, a scanner profile, and the like.

The display part 33 is composed of a liquid crystal display (LCD). The display part 33 displays various screens in accordance with instructions of display signals input from the CPU 31.

The operation part 34 receives various operations made by a user, and outputs operation signals based on the operations to the CPU 31. The operation part 34 includes a touch screen, a numeric keypad, a start button, a stop button, and the like.

The communication section 35 performs data communication with an external device. For example, the communication section 35 receives raster data from the printer controller 20. The communication section 35 receives a print instruction for a chart, an instruction to read a chart, and the like from the color management apparatus 50. The communication section 35 transmits data read by the inline reading section 40 to the color management apparatus 50.

The image forming section 36 forms an image on a sheet by an electrophotographic method. The image forming section 36 includes photosensitive drums 361C, 361M, 361Y, 361K and 361W corresponding to the colors of cyan (C), magenta (M), yellow (Y), black (K) and white (W), an intermediate transfer belt 362, a fixing section 363, and a reversing section 364. The image forming section 36 uniformly charges, for example, the photosensitive drum 361C corresponding to cyan, and then scans and exposes the photosensitive drum 361C with a laser beam based on image data of cyan to form an electrostatic latent image. The image forming section 36 makes cyan toner adhere to the electrostatic latent image on the photosensitive drum 361C for developing. Processes about the other colors are the same as the process about cyan. The image forming section 36 sequentially transfers the toner images of the colors formed on the photosensitive drums 361C, 361M, 361Y, 361K and 361W corresponding to the respective colors onto the intermediate transfer belt 362 (primary transfer). That is, a color toner image in which the toner images of the colors are superimposed is formed on the intermediate transfer belt 362. The image forming section 36 transfers the color toner image on the intermediate transfer belt 362 onto a sheet (secondary transfer). The fixing section 363 fixes the color toner image on the sheet by applying heat and pressure. In a case of performing image formation on both sides of the sheet, the reversing section 364 reverses the sheet with the image fixed on the front side, and conveys the reversed sheet to the image forming section 36 again. The CPU 31 controls the image forming section 36 on the basis of the raster data received from the printer controller 20 to form an image.

FIG. 3 illustrates an example of the image forming section 36 that performs image formation using toner of five colors (CMYKW) of cyan, magenta, yellow, black, and white. Alternatively, the toner used in the image forming section 36 may not include white, or may include a spot color other than white.

The document reading section 37 reads a sheet, a color sample, or the like placed on a document plate, and generates read data having pixel values of respective colors of red (R), green (G), and blue (B).

The sheet feed section 38 includes a plurality of sheet feed trays, and feeds sheets stored in each sheet feed tray to the image forming section 36.

The inline reading section 40 is provided on a conveyance path on the downstream side of the image forming section 36 in a sheet conveyance direction. The inline reading section 40 reads an image formed on a sheet and generates read data. The inline reading section 40 includes a colorimeter 41 and a scanner 42.

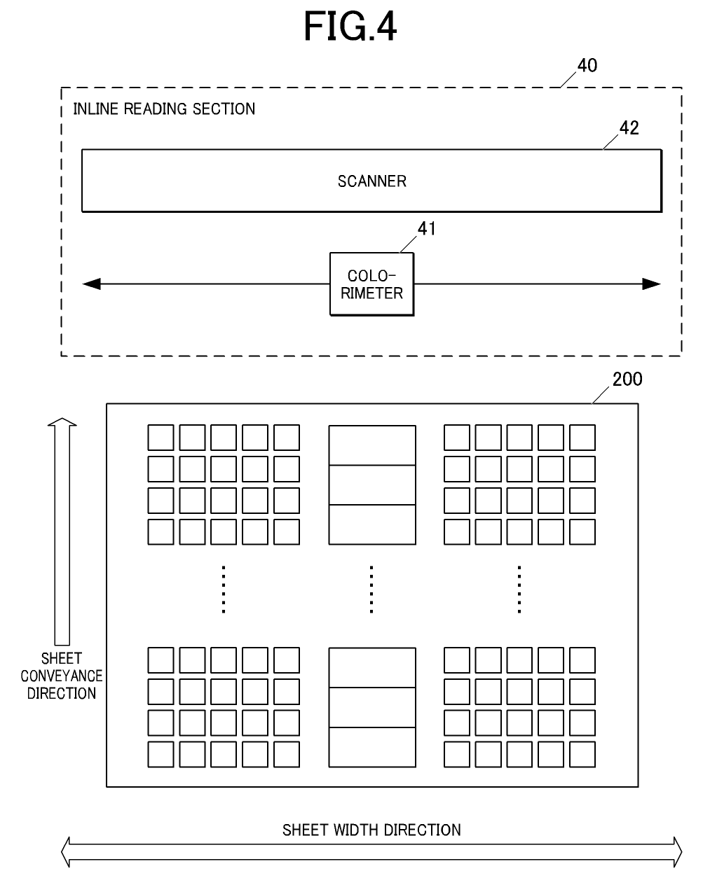

FIG. 4 schematically illustrates a positional relationship between the inline reading section 40 and a chart 200. As the chart 200 is conveyed, the inline reading section 40 can read different positions on the chart 200 in the sheet conveyance direction.

The colorimeter 41 is a spectral colorimeter and measures the absolute values of colors (L*a*b* values, XYZ values, etc.) accurately. The colorimeter 41 detects the spectral reflectance of an image formed on a sheet (chart 200) for each wavelength, and measures the color of the image. Reading by the colorimeter 41 includes a spot color measurement mode and a line color measurement mode.

The spot color measurement mode is a mode in which color measurement is performed one time on each patch. The spot color measurement mode is as if a shutter button is pressed one time for each patch in terms of a camera. That is, in the spot color measurement mode, the colorimeter 41 reads a partial area in a sheet width direction (main scanning direction) orthogonal to the sheet conveyance direction by one reading (color measurement).

The line color measurement mode is a mode in which time-series data of colorimetric values is obtained by performing skimming while moving the colorimeter 41. In terms of a camera, the line color measurement mode is as if the camera is moved while the shutter is left open. In the line color measurement mode, the colorimeter 41 may output the average value of colorimetric values obtained in the same patch as read data corresponding to the patch.

The colorimeter 41 is configured to be movable in the sheet width direction. The colorimeter 41 can read the entire sheet in the sheet width direction by moving in the sheet width direction. In other words, if the colorimeter 41 is not moved, the colorimeter 41 can read only a partial area in the sheet width direction. The colorimeter 41 is also used for correction (calibration) of the scanner 42.

The scanner 42 is fixed, and can read the entire sheet width direction by one reading. The scanner 42 reads a sheet (chart 200) conveyed thereto and generates read data having pixel values of red (R), green (G), and blue (B). The scanner 42 is, for example, a line type CCD sensor. In the reading by the scanner 42, the CPU 31 calculates colorimetric values (L*a*b* values, XYZ values, etc.) from RGB values.

Operation modes of the inline reading section 40 include a first operation mode and a second operation mode.

The first operation mode is an operation mode in which the colorimeter 41 moves a first width in the sheet width direction, and the colorimeter 41 reads all or some (one or more) of a plurality of patches arranged in the sheet width direction. The first operation mode is referred to as an "accuracy priority mode" because data read by the colorimeter 41 is mainly used. In the accuracy priority mode, the accuracy of colorimetric values is higher but the reading speed is lower than in the second operation mode. In the accuracy priority mode, for example, about 1,700 patches printed on the entire sheet are read by the colorimeter 41 and color adjustment is performed, so that high-accuracy color management is enabled.

The second operation mode is an operation mode in which the colorimeter 41 stops or moves a second width smaller than the first width in the sheet width direction, and the scanner 42 reads all or some (one or more) of the plurality of patches arranged in the sheet width direction. The second operation mode is referred to as a "speed priority mode" because data read by the scanner 42 is mainly used. In the speed priority mode, the reading speed is higher but the accuracy of colorimetric values is lower than in the accuracy priority mode.

Note that the accuracy priority mode and the speed priority mode are relative expressions. Depending on an operation mode to be compared with, the same operation mode may be the accuracy priority mode or the speed priority mode.

FIG. 5 illustrates a hardware configuration of the PC 10. The PC 10 includes a CPU 11, a storage section 12, a display part 13, an operation part 14, and a communication section 15.

The CPU 11 comprehensively controls processing operation of each component of the PC 10. The CPU 11 reads various process programs stored in the storage section 12, and performs various processes in cooperation with the programs.

The storage section 12 includes an HDD, an SSD, a nonvolatile memory, and the like. The storage section 12 stores various process programs such as a printer driver program 121, data related to various processes, and the like.

The display part 13 is composed of an LCD. The display part 13 displays various screens in accordance with instructions of display signals input from the CPU 11.

The operation part 14 includes a keyboard and a pointing device such as a mouse. The operation part 14 outputs, to the CPU 11, operation signals input by key operations on the keyboard and operations on the pointing device.

The communication section 15 performs data communication with an external device.

FIG. 6 shows a hardware configuration of the printer controller 20. The printer controller 20 includes a CPU 21, a storage section 22, a display part 23, an operation part 24, and a communication section 25. Since the components of the printer controller 20 are the same as the components of the PC 10, parts different from the PC 10 will be described.

A printer controller program 221 is stored in the storage section 22. A target profile, a printer profile, and the like are stored in the storage section 22.

FIG. 7 shows a hardware configuration of the color management apparatus 50. The color management apparatus 50 includes a CPU 51, a storage section 52, a display part 53, an operation part 54, and a communication section 55. Since the components of the color management apparatus 50 are the same as the components of the PC 10, parts different from the PC 10 will be described.

The storage section 52 stores a color management application program 521. A color management application is implemented by the CPU 51 in cooperation with the color management application program 521. The color management application provides a user interface for issuing an instruction to perform color management of the image forming apparatus(es) 30, checking a color verification result, calculating a correction value, and the like. Note that the method of using the color management application is not limited to the case where the program is locally installed. Alternatively, a color management application on a cloud may be used from the color management apparatus 50 via a browser in the form of an SaaS (Software as a Service) type service.

The storage section 52 stores a printer information table T1, a color management dataset table T2, and a color management preset table T3.

The printer information table T1 is a table for managing printer information on the plurality of image forming apparatuses 30 in the color management system 100.

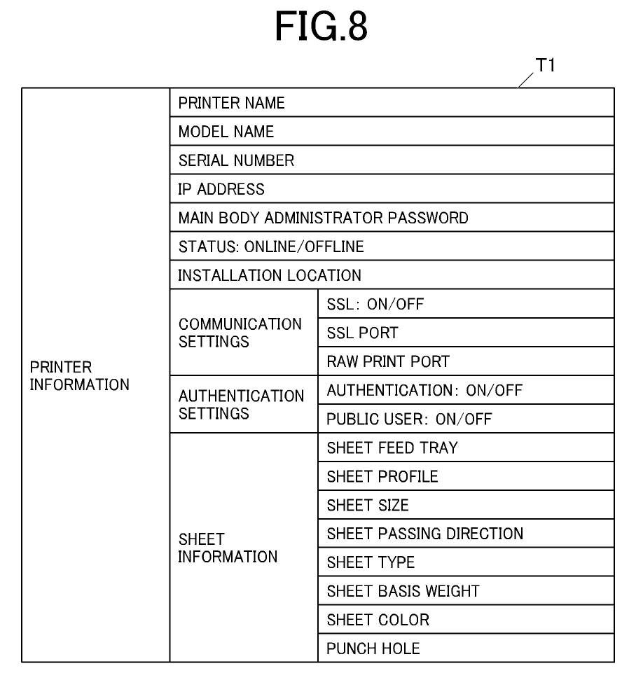

FIG. 8 shows an example of the data structure of the printer information table T1. In the printer information table T1, a printer name, a model name, a serial number, an IP address, a main body administrator password, a status, an installation location, communication settings, authentication settings, sheet information, and the like are associated with each of the image forming apparatuses 30.

The "printer name" is the name of the image forming apparatus 30 (printer).

The "model name" is the model name of the image forming apparatus 30.

The "serial number" is the serial number of the image forming apparatus 30.

The "IP address" is the IP address of the image forming apparatus 30. As the "IP address", each of the IP address of the image formation engine (image forming apparatus 30) and the IP address of the printer controller 20 may be managed.

The "main body administrator password" is the administrator password of the image forming apparatus 30.

The “status" is information indicating the state of the image forming apparatus 30. As the "status", online or offline can be set.

The "installation location" is the installation location of the image forming apparatus 30.

The "communication setting" is information indicating the communication setting of the image forming apparatus 30. The "communication setting" includes SSL (ON/OFF), an SSL port, and a RAW print port.

The "authentication setting" is information indicating the authentication setting of the image forming apparatus 30. The "authentication setting" includes authentication (ON/OFF) and a public user (ON/OFF).

The "sheet information" is information on the sheet(s) to be used in the image forming apparatus 30. The "sheet information" is information indicating the type of sheet, the sheet feed tray in which the sheet is stored, and the like. The "sheet information" includes a sheet feed tray, a sheet profile, a sheet size, a sheet passing direction, a sheet type, a sheet basis weight, a sheet color, a punch hole, and the like.

The color management dataset table T2 is a table for managing color management datasets (target configurations) that are used in the color management apparatus 50 (color management application). Each color management dataset includes setting of a colorimeter to be used for color management, setting of a chart to be used, an allowable value of color verification, settings for color correction, setting of an operation mode, and the like. The color management dataset includes various settings necessary for color measurement and so forth.

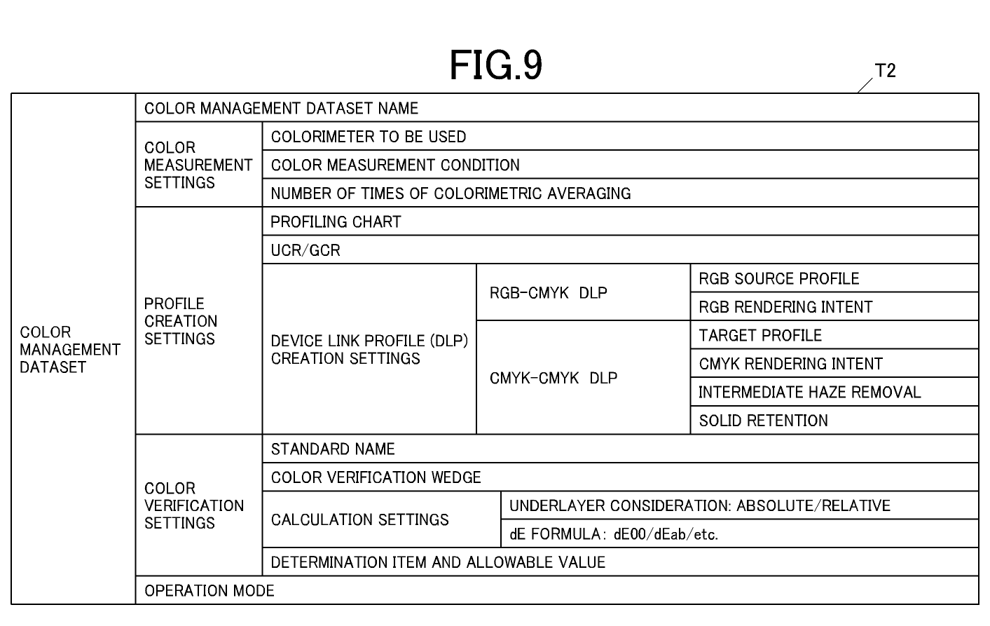

FIG. 9 shows an example of the data structure of the color management dataset table T2. In the color management dataset table T2, each color management dataset is associated with a color management dataset name, color measurement settings, profile creation settings, color verification settings, an operation mode, and the like.

The "color management dataset name" is the name of the color management dataset.

The "color measurement settings" are the settings related to the color measurement. The "color measurement settings" include a colorimeter to be used, a color measurement condition, and the number of times of colorimetric averaging.

When a colorimetric value is to be obtained, in consideration of stability during printing, a wedge or a chart is printed on a plurality of sheets, and colorimetric values are averaged for each patch. The "number of times of colorimetric averaging" is the number of copies of the wedge or chart used for the averaging. The "number of times of colorimetric averaging" is a value specified by the user.

The "profile creation settings" are the settings related to creation of a profile. The "profile creation settings" include a profiling chart, UCR/GCR, and device link profile (DLP) creation settings.

The "profiling chart" is a chart used for creating a profile (profiling).

The "UCR (Under Color Removal)” is to replace CMY of a shadow portion with a printing plate (K). "GCR (Gray Component Replacement)” is to replace CMY of a highlight portion to the shadow part, that is, all the gradation portion, with the printing plate (K).

The "DLP creation settings" include RGB-CMYK DLP (RGB source profile, RGB rendering intent) and CMYK-CMYK DLP (target profile, CMYK rendering intent, intermediate haze removal, solid retention).

The "intermediate haze removal" is a setting for reproducing a color that is composed of only a single color before color conversion, so as to be composed of only that color also after color conversion.

The "solid retention" is a setting for reproducing a solid portion before color conversion with a solid of the color also after color conversion.

The "color verification settings" are the settings related to the color verification. The "color verification settings" include a color verification’s standard name, a color verification wedge, calculation settings, and a determination item and allowable value.

The "calculation settings" include underlayer consideration (absolute/relative) and a dE formula (dE00, dEab, etc.).

The "determination item and allowable value" is a determination item determined by the standard and its allowable value. The "determination item and allowable value" is strictly set or loosely set according to the user’s application.

The "operation mode" is the operation mode in color management (in particular, reading of a chart) of the image forming apparatus 30.

The color management apparatus 50 performs a series of operations of color management by combining an image forming apparatus 30, setting of a sheet on which a chart is printed, and a color management dataset. The series of operations of the color management is a flow of printing a specified chart on a specified sheet, reading the chart with a specified reading device in a specified operation mode, performing color verification, and creating a profile for color adjustment from the result. Various settings related to color management are registered as a color management preset.

The color management preset is information in which a color management dataset, printer information, and sheet print setting information are associated with each other.

The color management preset table T3 is a table for managing color management presets.

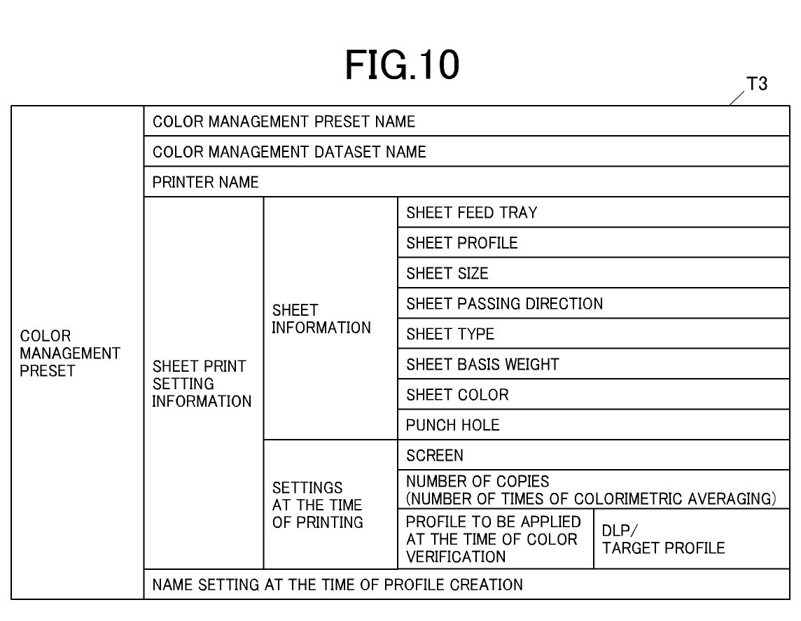

FIG. 10 shows an example of the data structure of the color management preset table T3. In the color management preset table T3, each color management preset is associated with a color management preset name, a color management dataset name, a printer name, sheet print setting information, a name setting at the time of profile creation, and the like.

The "color management preset name" is the name of a color management preset.

The "color management dataset name" is information with which a "color management dataset" constituting the color management preset is linked. Details of the "color management dataset" are obtained from the color management dataset table T2 on the basis of the "color management dataset name".

The "printer name" is information with which the "printer information" constituting the color management preset is linked. Details of the "printer information" are obtained from the printer information table T1 on the basis of the "printer name".

The "sheet print setting information" includes sheet information on a sheet to be subjected to the color management and settings at the time of printing.

The "sheet information" includes a sheet feed tray, a sheet profile, a sheet size, a sheet passing direction, a sheet type, a sheet basis weight, a sheet color, a punch hole, and the like.

The “settings at the time of printing" include a screen, the number of copies (the number of times of colorimetric averaging), a profile to be applied at the time of color verification (DLP/target profile), and the like.

The "name setting at the time of profile creation" includes a default name of each profile (printer profile, CMYK-CMYK DLP, RGB-CMYK DLP).

The CPU 51 obtains data read by the inline reading section 40 from the image forming apparatus 30 via the communication section 55. The read data is L*a*b* data if it is data read by the colorimeter 41, and is RGB data and/or L*a*b* data if it is data read by the scanner 42.

The CPU 51 (controller or hardware processor) performs color management of the image forming apparatus 30 based on reading data of a sheet by the inline reading section 40 (reader) set on a conveyance path of the sheet, on which the image forming section 36 of the image forming apparatus 30 has performed printing. The color management is at least one of color verification, creation of a color profile, and color correction.

The color verification is a function of comparing an actual reading result of a chart printed by the image forming apparatus 30 with a target value and verifying whether a color verification reference is satisfied.

The creation of a color profile is a function of creating a profile indicating color characteristics of the image forming apparatus 30.

The color correction is a function of correcting a color printed by the image forming apparatus 30.

When receiving the setting of the accuracy priority mode (first operation mode), the CPU 51 performs color management on the basis of the data read in the accuracy priority mode.

When receiving the setting of the speed priority mode (second operation mode), the CPU 51 performs color management on the basis of the data read in the speed priority mode.

As an example of the accuracy priority mode, in a mode A, the colorimeter 41 reads all patches of the plurality of patches arranged in the sheet width direction. Alternatively, there may be a patch(es) that is not read by the colorimeter 41 among the plurality of patches arranged in the sheet width direction.

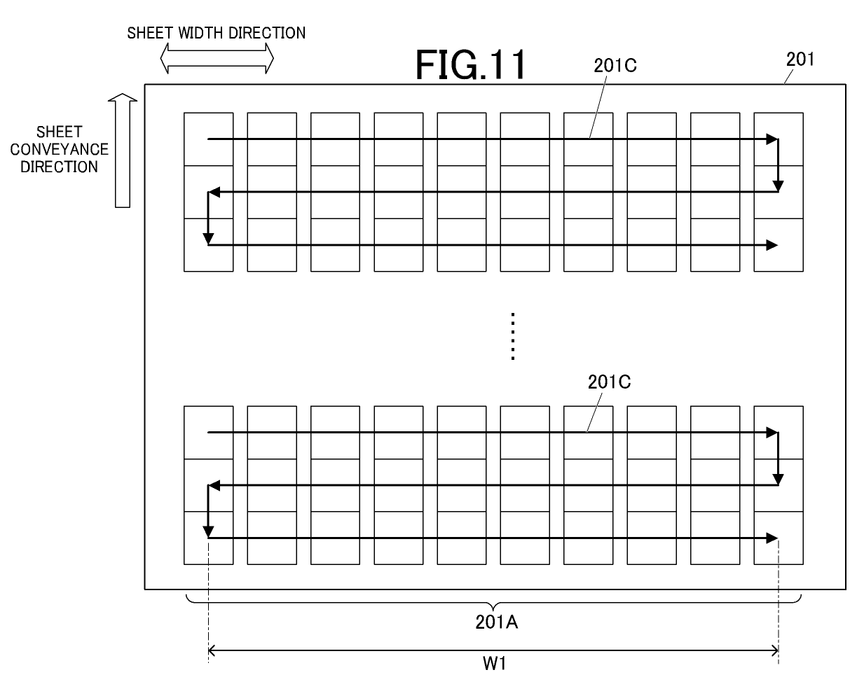

FIG. 11 illustrates an example of a chart 201 in a case where the mode A is set. In the mode A, the CPU 51 of the color management apparatus 50 performs color management using only the read data by the colorimeter 41. The CPU 31 of the image forming apparatus 30 performs color measurement while moving the colorimeter 41 in the sheet width direction so that the colorimeter 41 reads all the patches on the chart 201. The colorimeter 41 reads an area 201A of the chart 201 as a reading target. For example, the width W1 illustrated in FIG. 11 corresponds to a "first width" which the colorimeter 41 moves in the sheet width direction in the mode A. In FIG. 11, the width W1 is illustrated on the assumption that the colorimeter 41 reads the center position of the patches in the sheet width direction. Arrows 201C in FIG. 11 indicate the reading order of the patches by the colorimeter 41.

As an example of the accuracy priority mode, in a mode B, the colorimeter 41 reads part of the plurality of patches arranged in the sheet width direction, and the scanner 42 reads patches other than the part of the patches read by the colorimeter 41 among the plurality of patches arranged in the sheet width direction.

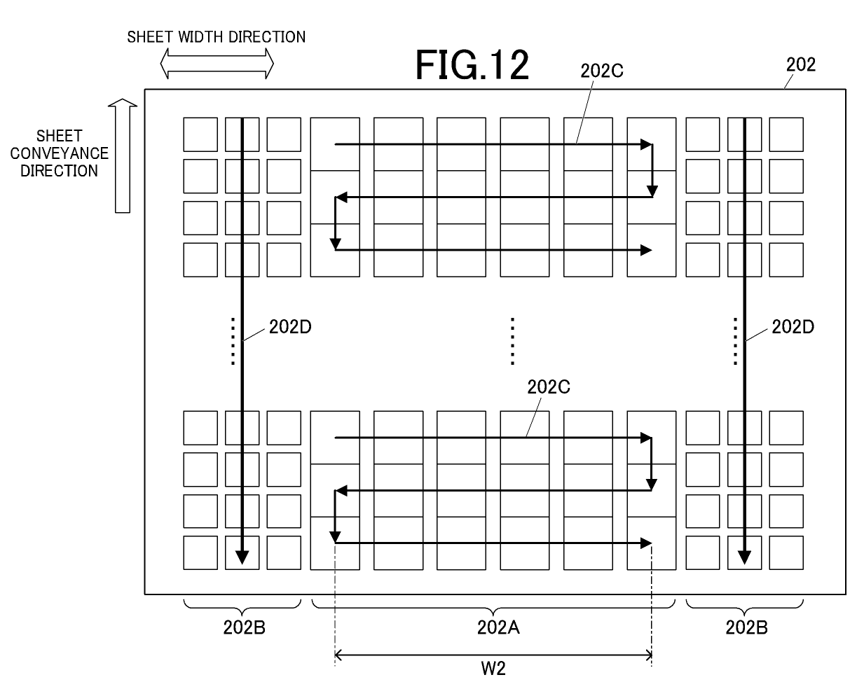

FIG. 12 illustrates an example of a chart 202 in a case where the mode B is set. In the mode B, the CPU 51 of the color management apparatus 50 performs color management using both read data by the colorimeter 41 and the scanner 42.

The CPU 31 of the image forming apparatus 30 performs color measurement while moving the colorimeter 41 in the sheet width direction so that the colorimeter 41 reads the patches of an area 202A on the chart 202. For example, the width W2 illustrated in FIG. 12 corresponds to the "first width" which the colorimeter 41 moves in the sheet width direction in the mode B. In FIG. 12, the width W2 is illustrated on the assumption that the colorimeter 41 reads the center position of the patches in the sheet width direction. Arrows 202C in FIG. 12 indicate the reading order of the patches by the colorimeter 41.

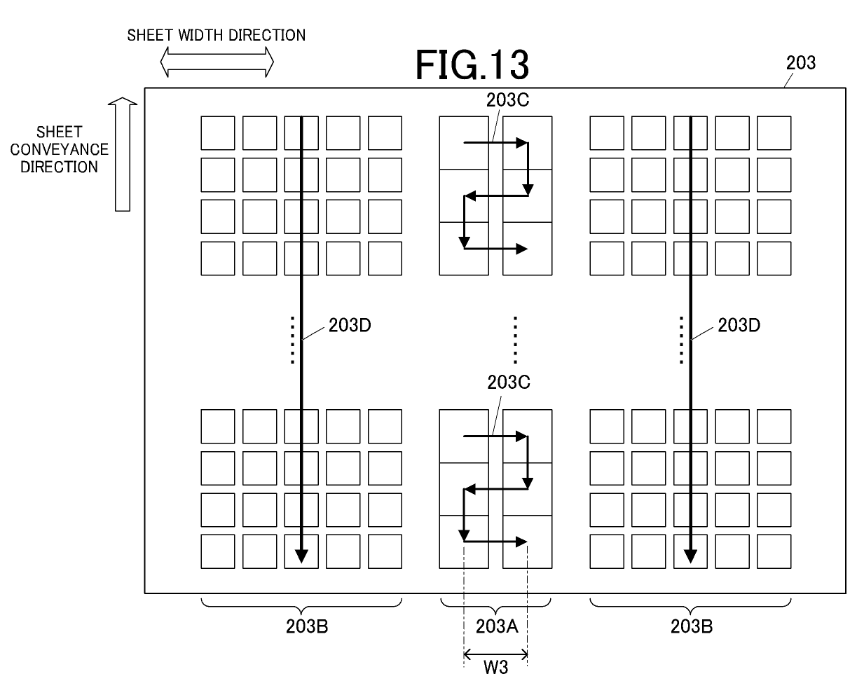

The CPU 31 causes the scanner 42 to read the patches in areas 202B on the chart 202. Arrows 202D in FIG. 12 indicate the reading order of the patches by the scanner 42. However, since the scanner 42 simultaneously reads a plurality of patches arranged in the sheet width direction, regardless of whether the arrows 202D are on patches in FIG. 12, patches at the same position in the sheet conveyance direction are simultaneously read. The same applies to arrows 203D, 204D, and 205D in FIG. 13 to FIG. 15.

As an example of the speed priority mode, in a mode C, the scanner 42 reads part of the plurality of patches arranged in the sheet width direction, and the colorimeter 41 reads patches other than the part of the patches read by the scanner 42 among the plurality of patches arranged in the sheet width direction.

FIG. 13 illustrates an example of a chart 203 in a case where a mode C is set. In the mode C, the CPU 51 of the color management apparatus 50 performs color management using both read data by the scanner 42 and the colorimeter 41.

The CPU 31 of the image forming apparatus 30 performs color measurement while moving the colorimeter 41 in the sheet width direction so that the colorimeter 41 reads the patches in areas 203A on the chart 203. For example, the width W3 illustrated in FIG. 13 corresponds to a "second width" which the colorimeter 41 moves in the sheet width direction in the mode C. In FIG. 13, the width W3 is illustrated on the assumption that the colorimeter 41 reads the center position of the patches in the sheet width direction. The width W3 which the colorimeter 41 moves in the sheet width direction in the mode C is smaller than the width W1 (see FIG. 11) which the colorimeter 41 moves in the sheet width direction in the mode A. The width W3 which the colorimeter 41 moves in the sheet width direction in the mode C is smaller than the width W2 (see FIG. 12) which the colorimeter 41 moves in the sheet width direction in the mode B. Arrows 203C in FIG. 13 indicate the reading order of the patches by the colorimeter 41.

The CPU 31 causes the scanner 42 to read patches in areas 203B on the chart 203. Arrows 203D in FIG. 13 indicate the reading order of the patches by the scanner 42.

As an example of the speed priority mode, in a mode D, the colorimeter 41 stops moving in the sheet width direction, and the scanner 42 reads all the patches of the plurality of patches arranged in the sheet width direction. Alternatively, among the plurality of patches arranged in the sheet width direction, there may be a patch(es) that the scanner 42 does not read.

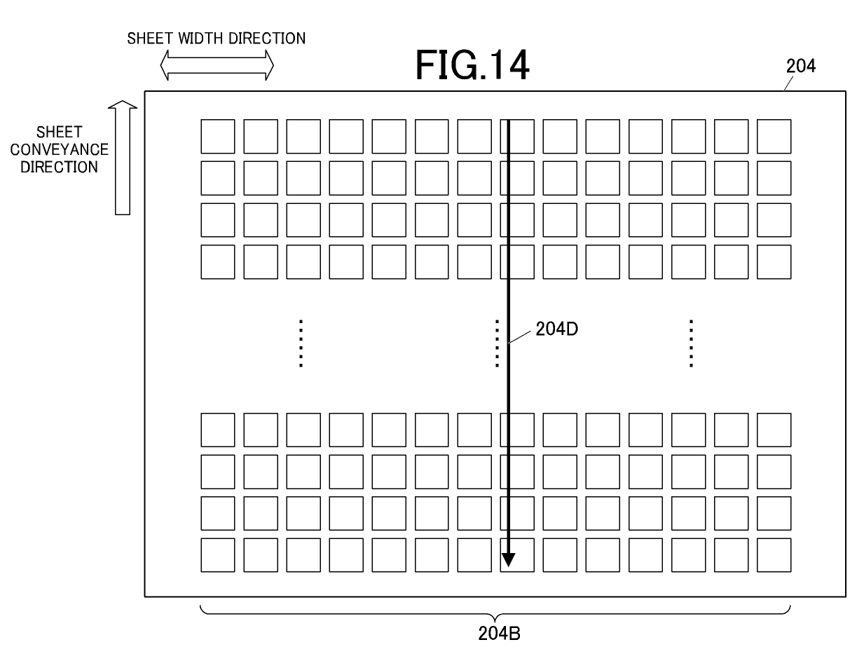

FIG. 14 illustrates an example of a chart 204in a case where the mode D is set. In the mode D, the CPU 51 of the color management apparatus 50 performs color management using only the read date by the scanner 42. The CPU 31 of the image forming apparatus 30 causes the scanner 42 to read the patches in an area 204B on the chart 204. An arrow 204D in FIG. 14 indicates the reading order of the patches by the scanner 42.

As for the proportion of the data read by the colorimeter 41 to the data read by the scanner 42, when the modes A to D are compared, the mode A has the highest proportion of the data read by the colorimeter 41 among the modes A to D. The mode D has the highest proportion of the data read by the scanner 42 among the modes A to D. The mode B has a higher proportion of the data read by the scanner 42 than the mode A, and has a higher proportion of the data read by the colorimeter 41 than in the modes C and D. The mode C has a higher proportion of the data read by the scanner 42 than the modes A and B, and has a higher proportion of the data read by the colorimeter 41 than the mode D.

The mode A has the largest number of patches read by the colorimeter 41 among the modes A to D. The mode D has the largest number of patches read by the scanner 42 among the modes A to D.

As an example of the speed priority mode, in a mode E, the CPU 31 (inline reading section 40) of the image forming apparatus 30 corrects the data read by the scanner 42 on the basis of the data read by the colorimeter 41.

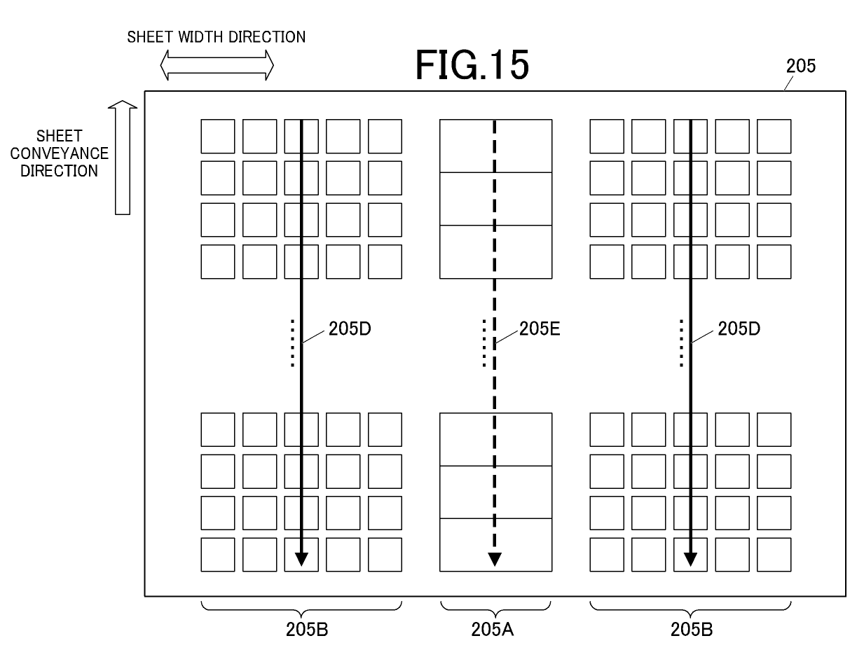

FIG. 15 shows an example of a chart 205 in a case where the mode E is set. In the mode E, the CPU 51 of the color management apparatus 50 performs color management using the read data by the scanner 42, the read data having been corrected based on the read data by the colorimeter 41.

The CPU 31 of the image forming apparatus 30 performs color measurement while stopping the colorimeter 41 in the sheet width direction so that the colorimeter 41 reads patches in an area 205A on the chart 205. An arrow 205E in FIG. 15 indicates the reading order of the patches by the colorimeter 41 for obtaining data for scanner correction.

The CPU 31 causes the scanner 42 to read patches in areas 205B on the chart 205. Arrows 205D in FIG. 15 indicate the reading order of the patches by the scanner 42.

Hereinafter, a method of correcting the data read by the scanner 42 based on the data read by the colorimeter 41 will be described.

The patches read by the scanner 42 include common color patches that are patches of the same color as the patches read by the colorimeter 41. The patches of the same color are patches formed with the same CMYK values (or CMYKW values) in the image forming section 36.

The CPU 31 of the image forming apparatus 30 obtains the L*a*b* values (measured L*a*b* values) of the common color patches read by the colorimeter 41.

The CPU 31 color-converts the RGB values of the common color patches read by the scanner 42 into L*a*b* values by the scanner profile of the scanner 42, and obtains the estimated L*a*b* values after the conversion.

The CPU 31 corrects the scanner profile of the scanner 42 based on the difference between the measured L*a*b* values and the estimated L*a*b* values in the common color patches (calibration of the scanner 42). The correction of the scanner profile corresponds to the correction of the data read by the scanner 42 based on the data read by the colorimeter 41. The CPU 31 converts the data read by the scanner 42 into L*a*b* values using the corrected scanner profile, and provides the same to the color management apparatus 50.

Which of the modes A and B is to be used as the accuracy priority mode (first operation mode) is stored in advance in the storage section 52 of the color management apparatus 50 and the storage section 32 of the image forming apparatus 30. When the mode D or E is used as the speed priority mode, the mode C can also be the accuracy priority mode.

Which of the modes C, D and E is to be used as the speed priority mode (second operation mode) is stored in advance in the storage section 52 of the color management apparatus 50 and the storage section 32 of the image forming apparatus 30. When the mode A is used as the accuracy priority mode, the mode B can also be the speed priority mode.

In the charts 201 to 205 illustrated in FIG. 11 to FIG. 15, the size of the patches read by the colorimeter 41 is larger than the size of the patches read by the scanner 42. Alternatively, the patches read by the colorimeter 41 and the patches read by the scanner 42 may have the same size.

Even if reading mainly by the colorimeter 41 and reading mainly by the scanner 42 can be set with respect to the inline reading section 40 of the image forming apparatus 30, the following problem is conceivable.

It is conceivable that the operator switches between use of the colorimeter 41 and use of the scanner 42 for color management in accordance with customer needs related to color matching. Specifically, the colorimeter 41 is used for a customer who requires high accuracy in color matching, and the scanner 42 is used for a customer who does not require high accuracy in color matching, thereby balancing QCD (quality, cost, and delivery date). The customer who requires high accuracy in color matching is a customer who requires a small color difference between colorimetric values (read values) and target colors. The customer who does not require high accuracy in color matching is a customer who has a large allowable value for a color difference between colorimetric values (read values) and target colors.

Meanwhile, with the advancement of image formation technologies, variations in image formation processes have increased, such as printing using a spot color toner, decorative printing, and printing on special sheets. In the color measurement by the scanner 42, since patches are collectively subjected to color measurement, read data (RGB values) may vary/fluctuate due to the influence of reflected light of adjacent patches or the like, resulting in a significant decrease in accuracy.

If the scanner 42 is used in such a situation, even for a customer who does not highly require accuracy in color matching, color matching is performed on a colorimetric value with low accuracy (a colorimetric value deviating from an original color). Even if a color difference reference is satisfied in terms of numerical value, there is a risk that customer needs in terms of quality may not be satisfied. In addition, in order to satisfy the needs in terms of quality, it is necessary to perform color matching by the colorimeter 41 and then perform printing again, and customer needs in terms of cost or delivery time may not be satisfied.

In this way, there are an increasing number of cases where customer needs cannot be satisfied by appropriate use of the operation modes according to simple indicators such as the magnitude of color difference.

Therefore, it is desirable that even an operator who lacks a skill for color matching can appropriately set the operation mode of the inline reading section 40 used for color management.

The CPU 51 of the color management apparatus 50 performs color management based on a color management dataset.

The CPU 51 receives setting of a color management dataset.

The CPU 51 obtains setting of an operation mode corresponding to the set color management dataset. The setting of an operation mode is information indicating either the accuracy priority mode (first operation mode) or the speed priority mode (second operation mode).

The CPU 51 performs color management based on the data read in the operation mode indicated by the obtained setting of the operation mode.

To be specific, the CPU 51 performs color management based on the data read in the operation mode indicated by the setting of the operation mode included in the set color management dataset.

When receiving setting of an operation mode indicating either the accuracy priority mode or the speed priority mode, the CPU 51 presents a processing time related to color management corresponding to the set operation mode. The processing time for color management includes not only the time for reading a sheet but also the time required for all or part of the color management. For example, the processing time for color management may include the time required for printing a chart and various kinds of arithmetic processing.

The image printed by the image forming apparatus 30 is a patch(es) for color management.

The CPU 51 determines the processing time for color management in accordance with the number of reading target patches and/or arrangement of the reading target patches.

The CPU 51 may present the processing time related to the color management only when receiving the setting of the accuracy priority mode. In this case, the user can check the processing time for the accuracy priority mode that is considered to require more time.

### Color Verification

Hereinafter, the color verification will be described.

The CPU 51 of the color management apparatus 50 causes the image forming apparatus 30 as a color management target to print a color verification chart (patch group). The CPU 51 transmits a print instruction to print a color verification chart to the printer controller 20 via the communication section 55. The print instruction to print a color verification chart includes specification of a color verification chart, specification of a sheet, a screen, the number of copies, a profile to be applied at the time of color verification, and the like. The CPU 21 of the printer controller 20 performs RIP processing or the like on chart data. The CPU 21 transmits a print instruction for a color verification chart including image data after processing to the image forming apparatus 30 as the color management target via the communication section 25. In the image forming apparatus 30 as the color management target, the CPU 31 controls the image forming section 36 to cause it to print a color verification chart.

Next, the CPU 51 of the color management apparatus 50 causes the image forming apparatus 30 as the color management target to read the color verification chart in the set operation mode. The CPU 51 transmits a reading instruction to read the color verification chart including the setting of the operation mode to the image forming apparatus 30 as the color management target via the communication section 55. In the image forming apparatus 30 as the color management target, the CPU 31 controls the inline reading section 40 (colorimeter 41, scanner 42) to read the color verification chart in the set operation mode. The CPU 51 of the color management apparatus 50 obtains the read data from the image forming apparatus 30 via the communication section 55.

Next, the CPU 51 of the color management apparatus 50 compares the read data (colorimetric values) with the color verification standard and their respective allowable values, and determines whether the color(s) printed by the image forming apparatus 30 satisfies a color verification reference. The CPU 51 causes the storage section 52 to store the determination result and causes the display part 53 to display the determination result.

### Color Profile Creation

Next, color profile creation will be described.

The CPU 51 of the color management apparatus 50 causes the image forming apparatus 30 as the color management target to print a chart for profile creation.

Next, the CPU 51 causes the image forming apparatus 30 as the color management target to read the chart for profile creation in the set operation mode. The CPU 51 obtains the read data from the image forming apparatus 30 via the communication section 55.

Printing and reading of a chart are the same as those in the case of color verification except that the target chart is different, and therefore detailed description will be omitted.

For the respective patches included in the chart for profile creation, the absolute values of target colors (L*a*b* values, etc.) are determined in advance.

The CPU 51 creates a color profile based on the difference between the read data (colorimetric value) on each patch and a target value. For example, the CPU 51 creates a printer profile, a device link profile, and the like. The CPU 51 transmits the created color profile to the image forming apparatus 30 as the color management target via the communication section 55.

In the image forming apparatus 30 as the color management target, the CPU 31 causes the storage section 32 to store the color profile.

### Color Correction

Next, color correction will be described. The color correction includes maximum density adjustment, in- plane unevenness adjustment, gradation adjustment, and the like in the image forming apparatus 30.

The CPU 51 of the color management apparatus 50 executes the color correction specified by the user.

The CPU 51 causes the image forming apparatus 30 as the color management target to print a chart for color correction.

Next, the CPU 51 causes the image forming apparatus 30 as the color management target to read the chart for color correction in the set operation mode. The CPU 51 obtains the read data from the image forming apparatus 30 via the communication section 55.

Printing and reading of a chart are the same as those in the case of color verification except that the target chart is different, and therefore detailed description will be omitted. Regarding the printing of the chart, in a case where the process in the printer controller 20 is unnecessary, a print instruction to print the chart is directly transmitted from the color management apparatus 50 to the image forming apparatus 30 as the color management target.

For example, in the case of the maximum density adjustment, the CPU 51 causes the display part 53 to display a comparison result between the measurement result of the maximum density and a predetermined target value for each color of CMYK (or CMYKW). The CPU 51 receives an input of an adjustment value related to the maximum density by a user’s operation on the operation part 54. Alternatively, the CPU 51 may automatically calculate an adjustment value related to the maximum density on the basis of the measurement result and the target value. The CPU 51 transmits the adjustment value related to the maximum density to the image forming apparatus 30 as the color management target via the communication section 55.

In the image forming apparatus 30 as the color management target, the CPU 31 allows the storage section 32 to store the adjustment value related to the maximum density.

### Color Matching to Color Sample

Next, color matching fto a color sample will be described.

The CPU 51 of the color management apparatus 50 creates (corrects) a target profile used when the color of a printed material by the image forming apparatus 30 is matched with the color of a color sample (target output material). The CPU 51 provides the created target profile to the image forming apparatus 30. The color sample is an output material received from the customer at the time of submission, and is not data but an actual output material. The target profile represents a correspondence relationship between document image data (CMYK values) input to a target printer that has printed the color sample and the colorimetric values (L*a*b* values) obtained from the color sample.

The CPU 51 obtains the document image data (CMYK values) corresponding to the color sample. The document image data is image data based on which the color sample has been printed, and is data submitted from the customer.

The CPU 51 obtains read image data (RGB values) obtained by the document reading section 37 of the image forming apparatus 30 reading the color sample. The CPU 51 converts the RGB values of the read image data into L*a*b* values using the scanner profile of the document reading section 37 prepared in advance. The scanner profile of the document reading section 37 is assumed to be reliable. The CPU 51 may obtain the colorimetric values (L*a*b* values) for the color sample from a colorimeter or the like connected to the color management apparatus 50.

The CPU 51 of the color management apparatus 50 creates a table in which the CMYK values and the L*a*b* values are associated with each other at corresponding positions in the document image data and the read image data. Based on this table, the CPU 51 creates a target profile for matching with the color of the color sample.

By combining the target profile creation and the printer profile creation, the color of the printed material by the image forming apparatus 30 can be matched with the color of the color sample.

Next, the operation in the color management system 100 will be described.

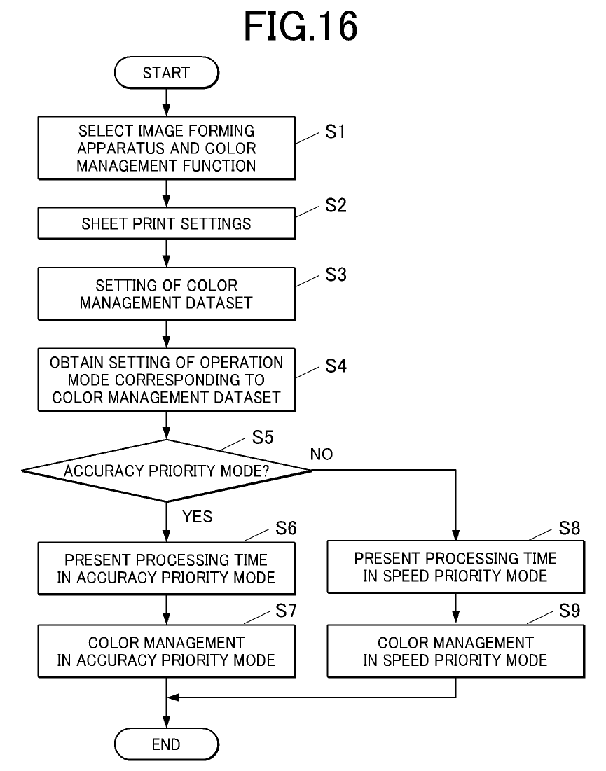

FIG. 16 is a flowchart illustrating a color management execution process that is executed in the color management apparatus 50.

First, the CPU 51 receives selection of an image forming apparatus 30 as the color management target and a color management function (Step S1). The user selects an image forming apparatus 30 and a color management function by making operations from the operation part 54. As the color management function, for example, one or two or more in combination of color verification, creation of a color profile, and color correction is selected.

Next, the CPU 51 receives sheet print settings (Step S2). The user sets various items of sheet information on a sheet as the color management target and settings at the time of printing by making operations from the operation part 54. Details of the sheet information and the settings at the time of printing are the same as the contents included in the color management preset table T3 (see FIG. 10).

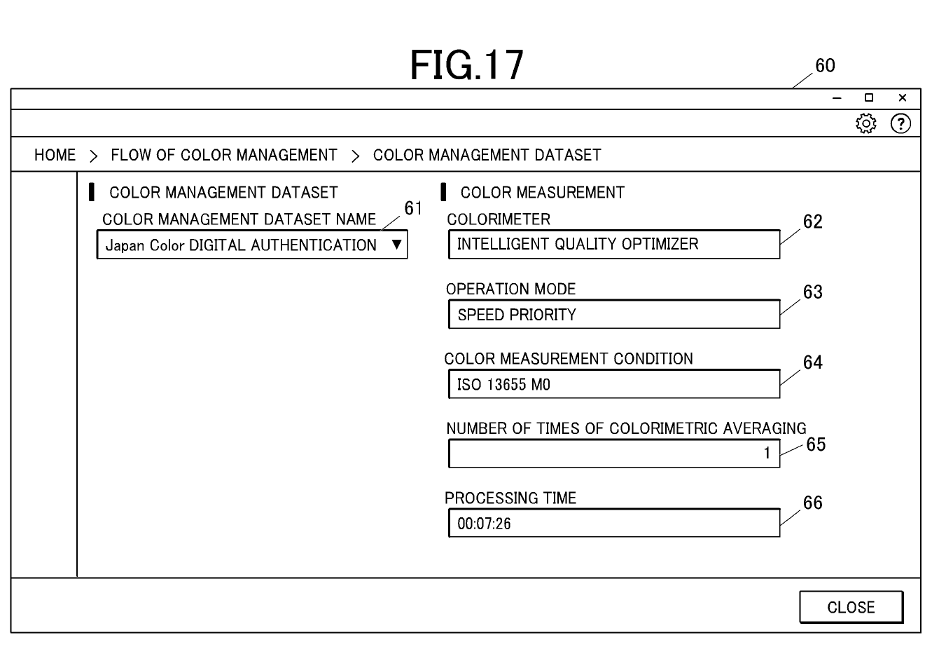

Next, the CPU 51 receives setting of a color management dataset (Step S3). The CPU 51 causes the display part 53 to display a color management dataset selection screen 60 illustrated in FIG. 17. The color management dataset selection screen 60 includes a color management dataset selection field 61, a colorimeter display field 62, an operation mode display field 63, a color measurement condition display field 64, a number of times of colorimetric averaging display field 65, a processing time display field 66, and the like.

The color management dataset selection field 61 is an area for selecting one of color management datasets (target configurations) registered in the color management dataset table T2 (see FIG. 9).

In each of the colorimeter display field 62, the operation mode display field 63, the color measurement condition display field 64, and the number of times of colorimetric averaging display field 65, various setting contents included in the color management dataset selected in the color management dataset selection field 61 are displayed.

The processing time related to color management corresponding to the operation mode displayed in the operation mode display field 63 is displayed in the processing time display field 66.

In the color management dataset selection field 61 of the color management dataset selection screen 60, the user sets one of the color management datasets by an operation from the operation part 54.

The CPU 51 obtains setting of an operation mode corresponding to the set color management dataset (Step S4). To be specific, the CPU 51 refers to the color management dataset table T2 and obtains a setting(s) of the operation mode included in the set color management dataset.

Next, the CPU 51 determines whether the operation mode indicated by the obtained setting of the operation mode is the accuracy priority mode (Step S5).

If the operation mode is the accuracy priority mode (Step S5; YES), the CPU 51 presents the processing time in the case of performing the color management in the accuracy priority mode to/on the display part 53 (Step S6). To be specific, the CPU 51 determines the processing time related to the color management in accordance with the number of patches included in a chart used for the color management and/or the arrangement of the patches. In the accuracy priority mode, since the colorimeter 41 mainly reads the sheet while moving in the sheet width direction, it takes longer time to perform color management than in the speed priority mode. The CPU 51 displays the processing time relating to the color management in the accuracy priority mode in the processing time display field 66 of the color management dataset selection screen 60.

Next, the CPU 51 performs color management related to the selected color management function in the accuracy priority mode on the image forming apparatus 30 that is the color management target (Step S7). The CPU 51 performs color management on the image forming apparatus 30 based on the color management dataset set in Step S3.

To be specific, the CPU 51 transmits a print instruction to print a chart to the printer controller 20 or the image forming apparatus 30 via the communication section 55. The CPU 51 transmits a reading instruction to read the chart in the accuracy priority mode to the image forming apparatus 30 via the communication section 55.

The CPU 31 of the image forming apparatus 30 controls the image forming section 36 to print the chart. The CPU 31 controls the inline reading section 40 to read the chart in the accuracy priority mode.

The CPU 51 of the color management apparatus 50 obtains data read in the accuracy priority mode from the image forming apparatus 30 via the communication section 55. The CPU 51 performs color management on the basis of the date read in the accuracy priority mode. Details of the color management are as described above.

In Step S5, if the operation mode is not the accuracy priority mode (Step S5; NO), the CPU 51 presents the processing time in the case of performing the color management in the speed priority mode to/on the display part 53 (Step S8). Details of the process of presenting the processing time are the same as those in Step S6. Since the scanner 42 mainly reads the sheet in the speed priority mode, time required for the color management is shorter than in the accuracy priority mode.

Next, the CPU 51 performs color management related the selected color management function in the speed priority mode on the image forming apparatus 30 as the color management target (Step S9). The CPU 51 performs color management on the image forming apparatus 30 based on the color management dataset set in Step S3.

To be specific, the CPU 51 transmits a print instruction to print a chart to the printer controller 20 or the image forming apparatus 30 via the communication section 55. The CPU 51 transmits a reading instruction to read the chart in the speed priority mode to the image forming apparatus 30 via the communication section 55.

The CPU 31 of the image forming apparatus 30 controls the image forming section 36 to print the chart. The CPU 31 controls the inline reading section 40 to read the chart in the speed priority mode.

The CPU 51 of the color management apparatus 50 obtains date read in the speed priority mode from the image forming apparatus 30 via the communication section 55. The CPU 51 performs color management based on the date read in the speed priority mode.

After Step S7 or Step S9, the color management execution process ends.

After Step S6 or Step S8, the operator may determine whether to perform color management in the set operation mode, in consideration of the presented processing time and the quality of the printed material. At the time of Step S6 or Step S8, if the operator determines not to perform color management in the set operation mode, the process may be performed again from Step S3.

According to the first embodiment, the CPU 51 of the color management apparatus 50 receives the setting of the accuracy priority mode (first operation mode) or the speed priority mode (second operation mode). The CPU 51 performs color management based on the data read in the set operation mode. Therefore, the operator can consciously set one of the operation modes different in proportion of data read by the colorimeter 41 and the scanner 42, with respect to the inline reading section 40 (reader) that is used for color management.

The CPU 51 also receives the setting of a color management dataset and obtains the setting of an operation mode corresponding to the set color management dataset. To be specific, the CPU 51 obtains the setting of the operation mode included in the set color management dataset. Therefore, the CPU 51 can obtain the setting of the operation mode in accordance with the setting of the color management dataset without forcing the operator to perform advanced determination.

For example, in the mode A (see FIG. 11), the CPU 51 performs color management using only the data read by the colorimeter 41. Therefore, the CPU 51 can perform color management with accuracy.

In the mode D (see FIG. 14), the CPU 51 performs color management using only the data read by the scanner 42. Therefore, the CPU 51 can suppress the time required for chart reading and can perform color management at high speed.

In the mode B (see FIG. 12) and the mode C (see FIG. 13), the CPU 51 performs color management using the data read by the colorimeter 41 and the scanner 42. Therefore, the CPU 51 can perform color management while balancing accuracy and speed.

In the mode E (see FIG. 15), the CPU 51 performs color management using the data read by the scanner 42 corrected based on the data read by the colorimeter 41. The CPU 51 can secure accuracy in color management by using the data read by the scanner 42 corrected based on the data read by the colorimeter 41. Further, since the colorimeter 41 does not move in the sheet width direction at the time of chart reading, the time required for chart reading can be suppressed.

Further, if the setting of the color management dataset is received, the CPU 51 obtains the setting of the operation mode corresponding to the set color management dataset, and presents the processing time related to the color management corresponding to the operation mode indicated by the setting of the operation mode. Thus, the operator can grasp the processing time for color management corresponding to the operation mode.

In addition, the CPU 51 determines the processing time for color management according to the number of target patches to be read and/or the arrangement of the patches. Thus, the CPU 51 can determine the processing time based on the configuration of the chart.

In the first embodiment, the setting of the operation mode is included in the color management dataset. The setting of the operation mode does not need to be included in the color management dataset, and may be managed as data separate from the color management dataset. It is sufficient that the CPU 51 of the color management apparatus 50 be able to specify the setting of the operation mode corresponding to the color management dataset when obtaining the setting of the operation mode.

Further, the operation mode corresponding to the color management dataset may not be registered in advance. For example, the operation mode may be automatically set based on a predetermined algorithm.

In the color management execution process (see FIG. 16), the CPU 51 of the color management apparatus 50 presents the processing time related to color management regardless of whether the operation mode is the accuracy priority mode or the speed priority mode. Alternatively, if the operation mode is the speed priority mode (Step S5; NO), the CPU 51 may omit Step S8, namely, presenting the processing time related to color management.

In the color management execution process described above, an operation mode is set in conjunction with the user setting a color management dataset. Alternatively, the user may directly set an operation mode at the time of execution of color management.

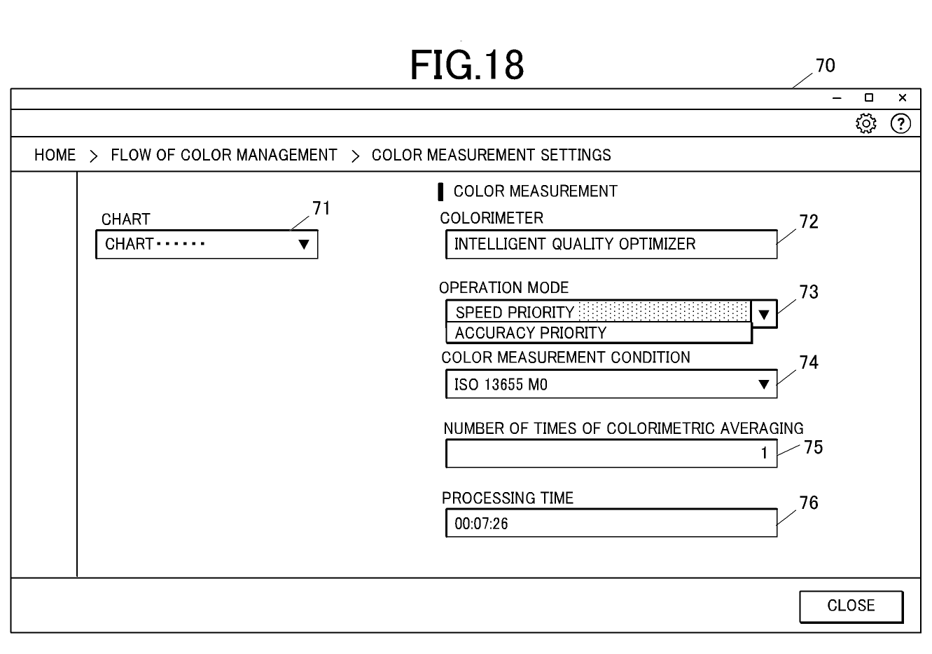

FIG. 18 illustrates an example of a color measurement setting screen 70 displayed on the display part 53 of the color management apparatus 50 in a case where the user directly sets an operation mode. The color measurement setting screen 70 includes a chart selection field 71, a colorimeter display field 72, an operation mode selection field 73, a color measurement condition selection field 74, a number of times of colorimetric averaging input field 75, a processing time display field 76, and the like.

The chart selection field 71 is an area for selecting one of the color management charts registered in advance.

The colorimeter corresponding to the operation mode selected in the operation mode selection field 73 is displayed in the colorimeter display field 72.

The operation mode selection field 73 is an area for selecting an operation mode. Here, options that are accuracy priority and speed priority are displayed as a pull-down menu, and one of the options can be selected. The above-described modes A to E may be displayed as options to be selectable.

The color measurement condition selection field 74 is an area for selecting a color measurement condition.

The number of times of colorimetric averaging input field 75 is an area for inputting the number of times of colorimetric averaging.

The processing time related to color management corresponding to the operation mode selected in the operation mode selection field 73 is displayed in the processing time display field 76.

The CPU 51 of the color management apparatus 50 receives the setting of the accuracy priority mode (first operation mode) or the speed priority mode (second operation mode) by a user operation from the operation part 54. The CPU 51 performs color management based on the data read in the set operation mode. Therefore, the operator can consciously set one of the operation modes different in proportion of data read by the colorimeter 41 and the scanner 42, with respect to the inline reading section 40 (reader) that is used for color management.

Further, when receiving the setting of the operation mode, the CPU 51 presents the processing time related to the color management corresponding to the set operation mode. To be specific, the CPU 51 displays the processing time related to the color measurement management corresponding to the set operation mode in the processing time display field 76 of the color measurement setting screen 70. Thus, the operator can grasp the processing time for color management corresponding to the operation mode.

### First Modification Example

A first modification example of the first embodiment will be described.

If the color management performed based on the data read in the speed priority mode (second operation mode) fails, the CPU 51 of the color management apparatus 50 performs the color management based on the data read in the accuracy priority mode (first operation mode).

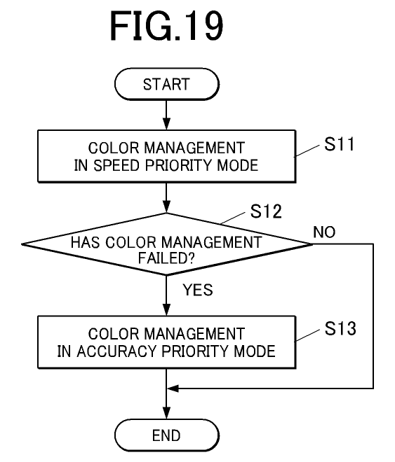

FIG. 19 is a flowchart illustrating a first additional process that is executed in the color management apparatus 50. This process is a process that is additionally executed following Step S9 of the color management execution process (see FIG. 16).

The CPU 51 performs color management related to the selected color management function in the speed priority mode on the image forming apparatus 30 as the color management target (Step S11). The CPU 51 performs color management based on the date read in the speed priority mode. In FIG. 19, the same contents as those of Step S9 are described as Step S11 for easy understanding.

Next, the CPU 51 determines whether color management has failed (Step S12). For example, the CPU 51 determines that the color management has failed if in color verification, the read data of the chart printed by the image forming apparatus 30 deviates from the target value of the standard. Also, the CPU 51 determines that the color management has failed if a predetermined standard is not satisfied in the creation of a color profile or the color correction.

If the CPU 51 determines that the color management has failed (Step S12; YES), the CPU 51 performs, on the image forming apparatus 30 as the color management target, color management related to the selected color management function in the accuracy priority mode (Step S13). The CPU 51 performs color management on the basis of the date read in the accuracy priority mode.

After Step S13 or if the CPU 51 determines that the color management has not failed in Step S12 (Step S12; NO), the first additional process ends.

According to the first modification example, if the color management fails, the CPU 51 of the color management apparatus 50 can perform the color management based on more accurate read data.

Note that if the color management performed based on the data read in the accuracy priority mode (first operation mode) fails, the CPU 51 of the color management apparatus 50 may perform color management based on the data read in the speed priority mode (second operation mode).

### Second Modification Example

A second modification example of the first embodiment will be described.

The CPU 51 of the color management apparatus 50 performs color management based on the data read in the accuracy priority mode (first operation mode), and then performs color management based on the data read in the speed priority mode (second operation mode) if the image forming apparatus 30 performs printing on a predetermined number of sheets.

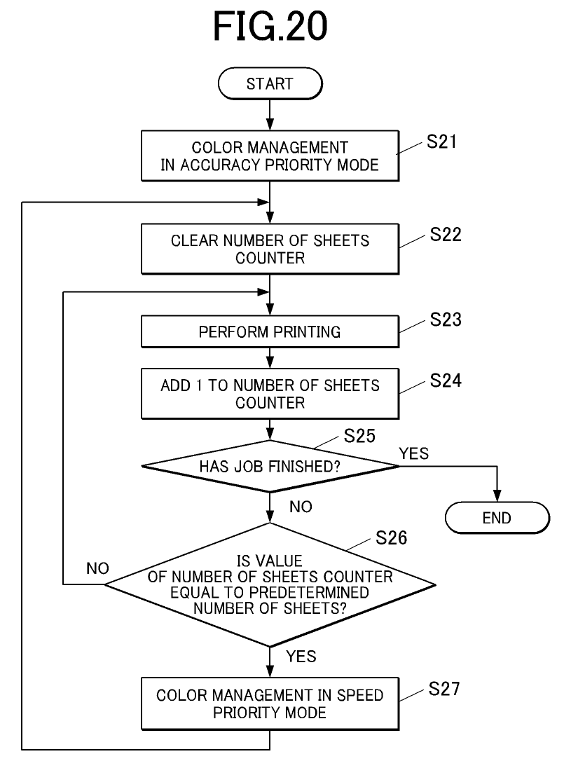

FIG. 20 is a flowchart illustrating a second additional process that is executed in the color management apparatus 50. This process is a process that is additionally executed following Step S7 of the color management execution process.

The CPU 51 performs color management related to the selected color management function in the accuracy priority mode on the image forming apparatus 30 as the color management target (Step S21). The CPU 51 performs color management on the basis of the date read in the accuracy priority mode. Note that in FIG. 20, for easy understanding, the same contents as those of Step S7 are described as Step S21.

Thereafter, the CPU 51 receives a notification indicating that a print job is to be executed from the image forming apparatus 30 that is the color management target via the communication section 55.

The CPU 51 clears a number of sheets counter corresponding to the image forming apparatus 30 as the color management target (Step S22). The number of sheets counter corresponding to each image forming apparatus 30 is stored in the storage section 52.

The CPU 51 receives, from the image forming apparatus 30 as the color management target, a notification indicating that printing has been performed on one sheet, via the communication section 55 (Step S23). The CPU 51 adds 1 to the number of sheets counter corresponding to the image forming apparatus 30 as the color management target (Step S24).

The CPU 51 determines whether the print job has finished in the image forming apparatus 30 that is the color management target (Step S25). For example, when receiving a notification indicating that the print job has finished from the image forming apparatus 30 as the color management target via the communication section 55, the CPU 51 determines that the print job has finished.

If the CPU 51 determines that the print job has not finished (Step S25; NO), the CPU 51 determines whether the value of the number of sheets counter matches a predetermined number of sheets (Step S26). The predetermined number of sheets is a value determined in advance as an execution interval of color management.

If the value of the number of sheets counter does not match the predetermined number of sheets (Step S26; NO), the process returns to Step S23.

In Step S26, if the value of the number of sheets counter matches the predetermined number of sheets (Step S26; YES), the CPU 51 performs the color management related to the selected color management function in the speed priority mode on the image forming apparatus 30 that is the color management target (Step S27). The CPU 51 performs color management based on the date read in the speed priority mode. Thereafter, the process returns to Step S22.

In Step S25, if the CPU 51 determines that the print job has finished (Step S25; YES), the second additional process ends.

In the second additional process, the processes in Step S22 to Step S26 may be performed by the image forming apparatus 30 that is the color management target. In this case, the CPU 51 of the color management apparatus 50 performs the process in Step S27 in response to receiving, from the image forming apparatus 30, the notification indicating that printing has been performed on the predetermined number of sheets.

According to the second modification example, the CPU 51 of the color management apparatus 50 can always maintain accurate color management by executing simple color management in the speed priority mode at predetermined (the number of printed sheets) intervals after executing color management in the accuracy priority mode once.

### Second Embodiment

Next, a second embodiment to which the present disclosure is applied will be described.

Since the color management system according to the second embodiment has the same configuration as the color management system 100 according to the first embodiment, the same constituent elements as those according to the first embodiment are denoted by the same reference signs, and descriptions thereof will be omitted. Hereinafter, characteristic configurations and processes of the second embodiment will be described.

In registration of a color management dataset, the CPU 51 of the color management apparatus 50 receives setting of an operation mode indicating either the accuracy priority mode (first operation mode) or the speed priority mode (second operation mode). When receiving the setting of an operation mode in registration of a color management dataset, the CPU 51 presents the processing time related to the color management corresponding to the set operation mode.

Next, the operation of the color management system 100 according to the second embodiment will be described.

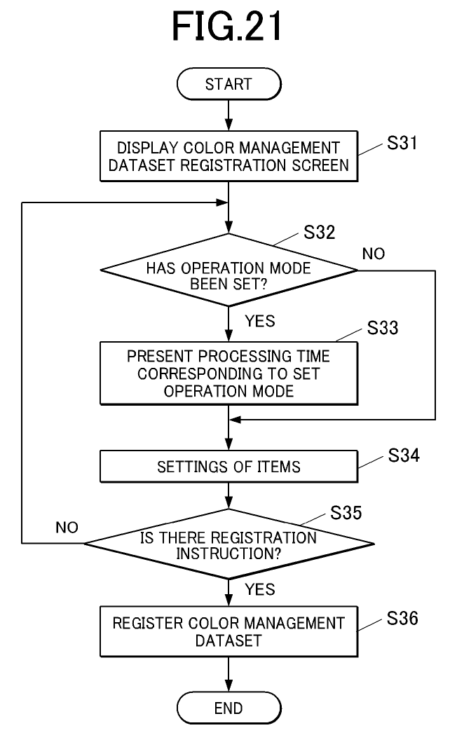

FIG. 21 is a flowchart illustrating a first color management dataset registration process that is executed in the color management apparatus 50.

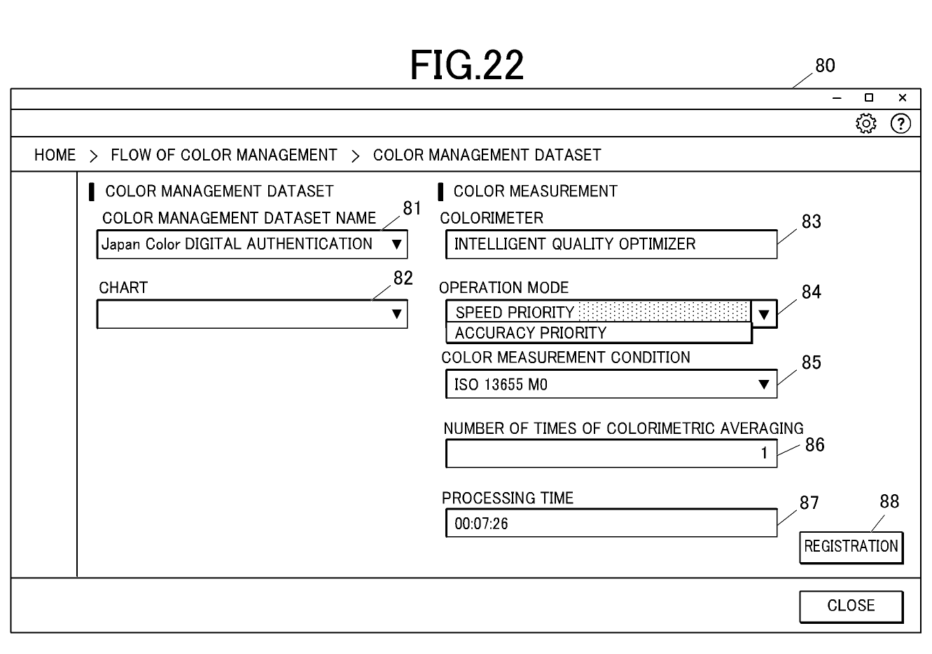

First, the CPU 51 causes the display part 53 to display a color management dataset registration screen 80 illustrated in FIG. 22 (Step S31). The color management dataset registration screen 80 includes a color management dataset name input field 81, a chart selection field 82, a colorimeter selection field 83, an operation mode selection field 84, a color measurement condition selection field 85, a number of times of colorimetric averaging input field 86, a processing time display field 87, and a register button 88.

The color management dataset name input field 81 is an area for inputting a name of a color management dataset to be newly registered.

The chart selection field 82 is an area for selecting a chart to be used for color management.

The colorimeter selection field 83 is an area for selecting a color colorimeter.

The operation mode selection field 84 is an area for selecting an operation mode.

The color measurement condition selection field 85 is an area for selecting a color measurement condition.

The number of times of colorimetric averaging input field 86 is an area for inputting the number of times of colorimetric averaging.

In the processing time display field 87, the processing time related to the color management corresponding to the operation mode selected in the operation mode selection field 84 is displayed.

The register button 88 is a button for issuing an instruction to register a color management dataset.

The CPU 51 determines whether an operation mode has been set on the color management dataset registration screen 80 (Step S32). The user sets one of the operation modes (accuracy priority mode and speed priority mode) in the operation mode selection field 84 by making an operation from the operation part 54.

If the CPU 51 determines that the operation mode has been set (Step S32; YES), the CPU 51 presents the processing time corresponding to the set operation mode on the display part 53 (Step S33). To be specific, the CPU 51 determines the processing time related to the color management in accordance with the number of patches included in the chart selected in the chart selection field 82 and/or the arrangement of the patches. The CPU 51 displays the processing time related to the color management corresponding to the set operation mode in the processing time display field 87 of the color management dataset registration screen 80.

After Step S33 or if the CPU 51 determines that the operation mode has not been set in Step S32 (Step S32; NO), the CPU 51 receives settings about the items of the color management dataset (Step S34). Although not illustrated in FIG. 22, each item included in the color management dataset table T2 (see FIG. 9) can be set. The user sets each item by making an operation from the operation part 54.

Next, the CPU 51 determines whether a registration instruction to register the color management dataset has been issued by an operation from the operation part 54 (Step S35). To be specific, the CPU 51 determines whether the register button 88 has been pressed on the color management dataset registration screen 80.

If the registration button 88 has not been pressed (Step S35; NO), the process returns to Step S32.

If the registration button 88 has been pressed in Step S35 (Step S35; YES), the CPU 51 registers the color management dataset with the set contents (Step S36). To be specific, the CPU 51 associates and stores the color management dataset name, the operation mode, and the like in the color management dataset table T2.

Thus, the first color management dataset registration process ends.

According to the second embodiment, when the CPU 51 of the color management apparatus 50 receives setting of an operation mode in registration of a color management dataset, it presents the processing time related to the color management corresponding to the set operation mode. Thus, the operator can grasp the processing time for color management corresponding to the operation mode.

### Third Embodiment

Next, a third embodiment to which the present disclosure is applied will be described.

Since the color management system according to the third embodiment has the same configuration as the color management system 100 according to the first embodiment, the same constituent elements as those according to the first embodiment are denoted by the same reference signs, and descriptions thereof will be omitted. Hereinafter, characteristic configurations and processes of the third embodiment will be described.

The color management dataset includes settings of a chart to be used in color management. In the color management dataset table T2 shown in FIG. 9, the profiling chart and the color verification wedge correspond to the “chart to be used in color management".

Further, the storage section 52 of the color management apparatus 50 stores in advance a correspondence relationship between a chart that is used in color management and an operation mode for reading the chart.

The CPU 51 of a color management apparatus 50 automatically sets an operation mode corresponding to a set chart according to the setting of the chart in the registration of the color management dataset. For example, the CPU 51 automatically sets the accuracy priority mode in a case where a chart with a small number of patches is set. The CPU 51 automatically sets the speed priority mode in a case where a chart with a large number of patches is set. Further, the CPU 51 automatically sets the accuracy priority mode in a case where a high-accuracy color management chart is set.

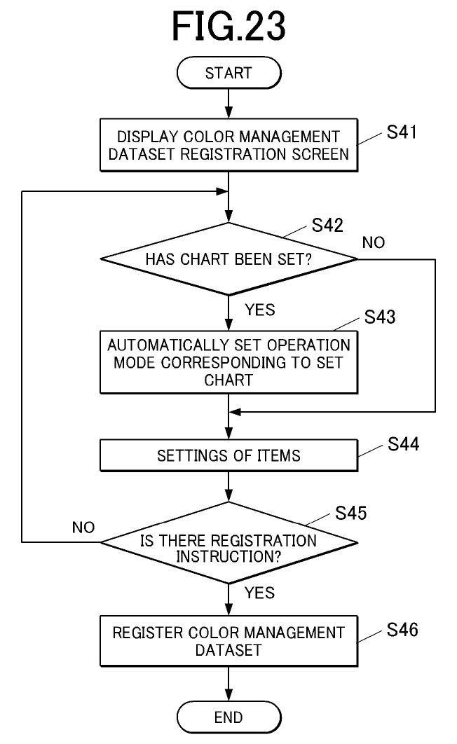

FIG. 23 is a flowchart illustrating a second color management dataset registration process that is executed in the color management apparatus 50.

The process in Step S41 is the same as the process in Step S31 in the first color management dataset registration process (see FIG. 21), and therefore description thereof will be omitted.

Next, the CPU 51 determines whether a chart has been set on the color management dataset registration screen 80 shown in FIG. 22 (Step S42). The user sets one of the charts in the chart selection field 82 by making an operation from the operation part 54.

If the CPU 51 determines that a chart has been set (Step S42; YES), the CPU 51 automatically sets the operation mode corresponding to the set chart (Step S43). The CPU 51 causes the operation mode corresponding to the set chart to be displayed in the operation mode selection field 84.

After Step S43 or if no chart is set in Step S42 (Step S42; NO), the process proceeds to Step S44.

Processes in Step S44 to Step S46 are the same as the processes in Step S34 to Step S36 in the first color management dataset registration process, and therefore descriptions thereof will be omitted.

According to the third embodiment, the CPU 51 of the color management apparatus 50 automatically sets the operation mode corresponding to the set chart in accordance with the setting of the chart in the registration of the color management dataset. Therefore, even an operator who has little experience in color management can easily set an operation mode.

In the third embodiment, an operation mode is automatically set in conjunction with setting of a chart. Alternatively, an operation mode may be automatically set in conjunction with setting of a color management standard.

The color management dataset includes setting of a color management standard. In the color management dataset table T2 illustrated in FIG. 9, the color verification settings correspond to the "color management standard".

Further, the storage section 52 of the color management apparatus 50 stores in advance a correspondence relationship between a color management standard and an operation mode for performing color management based on the color management standard.

In the registration of the color management dataset, the CPU 51 of the color management apparatus 50 automatically sets, according to the setting of the color management standard, the operation mode corresponding to the set color management standard. Depending on the setting of the color management standard, whether high-accuracy color management is necessary or simple color management is sufficient is different. Therefore, the CPU 51 automatically sets the operation mode according to the degree of severity in the color management standard.

To be specific, the "chart" in Step S42 and Step S43 of the second color management dataset registration process (see FIG. 23) can be read as the "color management standard".

In this case too, even an operator who has little experience in color management can easily set an operation mode.

### Fourth Embodiment

Next, a fourth embodiment to which the present disclosure is applied will be described.

Since the color management system according to the fourth embodiment has the same configuration as the color management system 100 according to the first embodiment, the same constituent elements as those according to the first embodiment are denoted by the same reference signs, and descriptions thereof will be omitted. Hereinafter, characteristic configurations and processes of the fourth embodiment will be described.

The plurality of image forming apparatuses 30 to be subjected to color management may include an image forming apparatus 30 whose inline reading section 40 (reader) set on the conveyance path of the sheet on which the image forming apparatus 30 has performed printing may not have the accuracy priority mode (first operation mode).

In the fourth embodiment, the printer information table T1 (see FIG. 8) includes, as the printer information on each image forming apparatus 30, information indicating whether the image forming apparatus 30 (inline reading section 40) has the accuracy priority mode.

The color management cannot be performed by combining the color management dataset including the setting of the accuracy priority mode and the image forming apparatus 30 that does not have the accuracy priority mode. Therefore, the CPU 51 of the color management apparatus 50 prohibits the color management dataset including the setting of the accuracy priority mode from being associated with an image forming apparatus 30 not having the accuracy priority mode.

Next, the operation of the color management system 100 according to the fourth embodiment will be described.

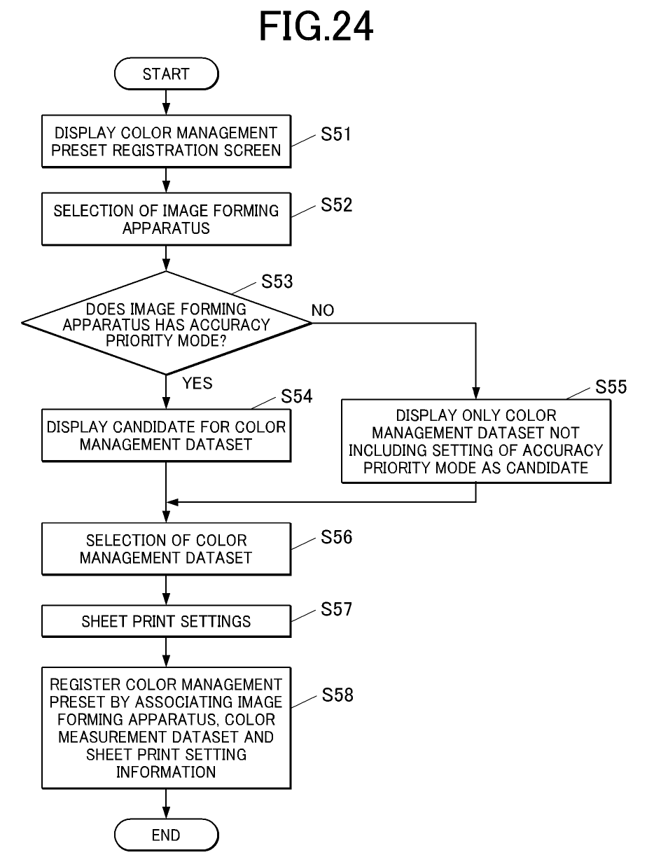

FIG. 24 is a flowchart illustrating a first color management preset registration process that is executed in the color management apparatus 50.

First, the CPU 51 of the color management apparatus 50 causes the display part 53 to display a color management preset registration screen (Step S51).

The CPU 51 receives selection of an image forming apparatus 30 as the color management (Step S52). The user selects an image forming apparatus 30 by making an operation from the operation part 54.

Next, the CPU 51 refers to the printer information table T1 and determines whether the inline reading section 40 of the selected image forming apparatus 30 has the accuracy priority mode (Step S53).

If the inline reading section 40 of the selected image forming apparatus 30 has the accuracy priority mode (Step S53; YES), the CPU 51 causes the display part 53 to display candidates for the color management dataset (Step S54). Here, the CPU 51 allows all the color management datasets registered in the color management dataset table T2 (see FIG. 9) to be displayed without any particular limitation.

In Step S53, if the inline reading section 40 of the selected image forming apparatus 30 does not have the accuracy priority mode (Step S53; NO), the process proceeds to Step S55. In Step S55, the CPU 51 causes the display part 53 to display, as candidates, only the color management datasets not including the setting of the accuracy priority mode among the color management datasets registered in the color management dataset table T2. That is, the CPU 51 excludes, from candidates, the color management datasets including the setting of the accuracy priority mode.

After Step S54 or Step S55, the CPU 51 receives selection of one of the color management datasets displayed as candidates (Step S56). The user selects a color management dataset by making an operation from the operation part 54.

Next, the CPU 51 receives sheet print settings (Step S57). The user sets various items regarding the sheet information on the sheet to be the target of the color management and the setting at the time of printing by making operations from the operation part 54. Details of the sheet information and the setting at the time of printing are the same as the contents included in the color management preset table T3 (see FIG. 10).

Next, the CPU 51 registers the color management preset by associating the selected image forming apparatus 30, the selected color management dataset, and the sheet print setting information (Step S58). To be specific, the CPU 51 associates and stores a printer name, a color management dataset name, sheet print setting information, and the like in the color management preset table T3.

Thus, the first color management preset registration process ends.

According to the fourth embodiment, the CPU 51 of the color management apparatus 50 prohibits the color management dataset including the setting of the accuracy priority mode (first operation mode) from being associated with the image forming apparatus 30 not having the accuracy priority mode. Since the CPU 51 prohibits association of the color management dataset and the image forming apparatus 30 that cannot be combined in execution of color management, an error can be prevented from occurring.

In the first color management preset registration process, only the color management datasets not including the setting of the accuracy priority mode are set as the candidates in Step S55. Alternatively, the CPU 51 may select a color management dataset from all the color management datasets and display a warning when the selected color management dataset includes the setting of the accuracy priority mode. For example, the CPU 51 causes the display part 53 to display a message stating that the selected color management dataset cannot be associated with the selected image forming apparatus 30.

In the first color management preset registration process, the process for registering a color management preset has been described. Alternatively, the CPU 51 of the color management apparatus 50 may prohibit the color management dataset including the setting of the accuracy priority mode from being associated with the image forming apparatus 30 not having the accuracy priority mode, when the color management is executed.

### Fifth Embodiment

Next, a fifth embodiment to which the present disclosure is applied will be described.

Since the color management system according to the fifth embodiment has the same configuration as the color management system 100 according to the first embodiment, the same constituent elements as those according to the first embodiment are denoted by the same reference signs, and descriptions thereof will be omitted. Hereinafter, characteristic configurations and processes of the fifth embodiment will be described.

The plurality of image forming apparatuses 30 to be subjected to color management may include an image forming apparatus 30 whose inline reading section 40 (reader) set on the conveyance path of the sheet on which the image forming apparatus 30 has performed printing may not have the accuracy priority mode (first operation mode).

In the fifth embodiment too, the printer information table T1 (see FIG. 8) includes, as the printer information on each image forming apparatus 30, information indicating whether the image forming apparatus 30 (inline reading section 40) has the accuracy priority mode.

When a color management dataset including the setting of the accuracy priority mode is associated with the image forming apparatus 30 not having the accuracy priority mode, the CPU 51 of the color management apparatus 50 automatically changes the setting of the operation mode included in the color management dataset to the speed priority mode (second operation mode).

Next, the operation in the color management system 100 according to the fifth embodiment will be described.

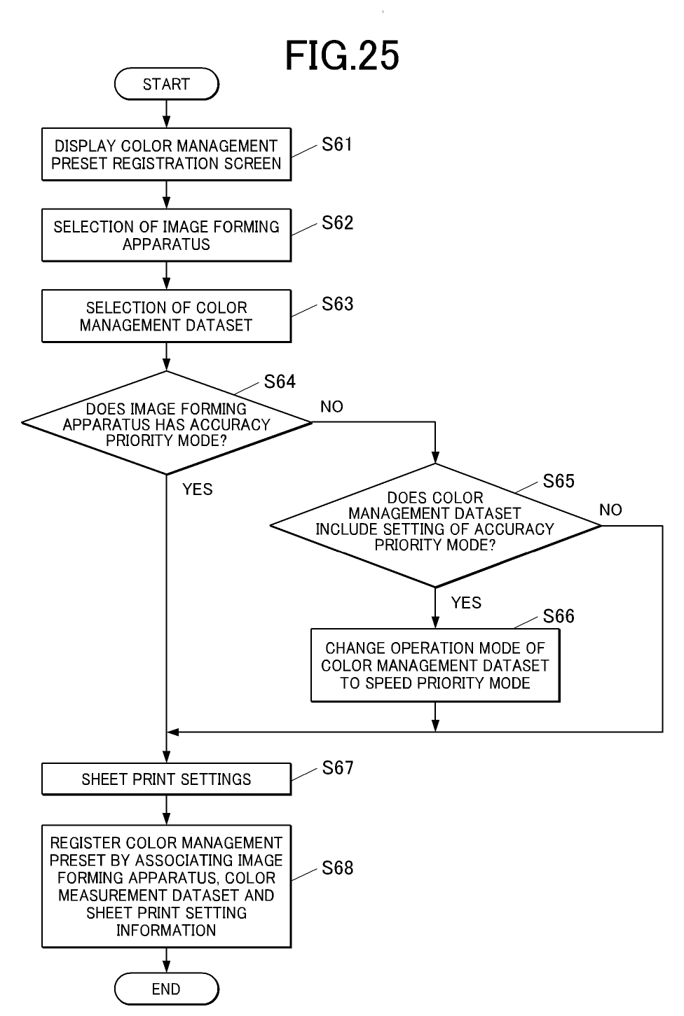

FIG. 25 is a flowchart illustrating a second color management preset registration process that is executed in the color management apparatus 50.

The processes in Step S61 and Step S62 are the same as the processes in Step S51 and Step S52 in the first color management preset registration process (see FIG. 24), and therefore descriptions thereof will be omitted.

Next, the CPU 51 receives selection of a color management dataset (Step S63). The CPU 51 causes color management datasets registered in the color management dataset table T2 (see FIG. 9) to be displayed as candidates. The user selects a color management dataset by making an operation from the operation part 54.

Next, the CPU 51 refers to the printer information table T1 and determines whether the inline reading section 40 of the selected image forming apparatus 30 has the accuracy priority mode (Step S64).

In a case where the inline reading section 40 of the selected image forming apparatus 30 does not have the accuracy priority mode (Step S64; NO), the process proceeds to Step S65. In Step S65, the CPU 51 refers to the color management dataset table T2 and determines whether the selected color management dataset includes the setting of the accuracy priority mode.

If the selected color management dataset includes the setting of the accuracy priority mode (Step S65; YES), the CPU 51 changes the operation mode of the color management dataset to the speed priority mode (Step S66). The CPU 51 may re-register, under a different name, the color management dataset after the operation mode setting is changed.

In Step S64, if the inline reading section 40 of the selected image forming apparatus 30 has the accuracy priority mode (Step S64; YES), the process proceeds to Step S67.

After Step S66 or if the selected color management dataset does not include the setting of the accuracy priority mode in Step S65 (Step S65; NO), the process proceeds to Step S67.

Processes in Step S67 and Step S68 are the same as those in Step S57 and Step S58 of the first color management preset registration process (see FIG. 24), and therefore descriptions thereof will be omitted.

Provided that if the setting of the operation mode included in the color management dataset is changed in Step S66, the CPU 51 registers the color management preset using the color management dataset after the change in Step S68.

Thus, the second color management preset registration process ends.

According to the fifth embodiment, if the color management dataset including the setting of the accuracy priority mode (first operation mode) is associated with the image forming apparatus 30 not having the accuracy priority mode, the CPU 51 of the color management apparatus 50 automatically changes the setting of the operation mode included in the color management dataset to the speed priority mode (second operation mode). Since the CPU 51 changes the setting of the operation mode included in the color management dataset for the color management dataset and the image forming apparatus 30 that cannot be combined in execution of color management, an error can be prevented from occurring.

In the second color management preset registration process, the process for registering a color management preset has been described. Alternatively, the CPU 51 of the color management apparatus 50 may automatically change the setting of the operation mode included in the color management dataset to the speed priority mode when the color management is executed, if the color management dataset including the setting of the accuracy priority mode is associated with the image forming apparatus 30 not having the accuracy priority mode.

Those described in the above-described embodiments and modification examples are examples of the color management method, the color management apparatus and the program(s) according to the present disclosure, and the present disclosure is not limited thereto. The detailed configuration and detailed operation of each apparatus constituting the system can also be appropriately changed without departing from the scope of the present disclosure.

For example, characteristic processes in the respective embodiments and modification examples may be executed in combination.

Further, the types of operation modes and the number of operation modes in the color management of the image forming apparatus 30 are not limited to the above-described examples.

Further, the charts used in the color management are not limited to the charts 201 to 205 illustrated in FIG. 11 to FIG. 15. The number or arrangement of patches included in each chart can also be appropriately changed.

Further, in the above, the inline reading section 40 is a part of the image forming apparatus 30, but the inline reading section 40 may be an inline reading device independent from the image forming apparatus 30.

Further, the color management apparatus 50 may be an independent apparatus or may be included in another apparatus/device. For example, the color management apparatus 50 may be included in the printer controller 20 or the image forming apparatus 30, or may be included in the aforementioned inline reading device.

Further, in each of the above-described embodiments and modification examples, each process performed by the CPU 51 (color management application) of the color management apparatus 50 may be performed by another apparatus in the color management system 100 or an apparatus connectable to the color management system 100. Further, each process performed by the CPU 51 of the color management apparatus 50 may be performed by a plurality of apparatuses in cooperation with each other.

In each of the above embodiments and modification examples, the image forming apparatus 30 is an electrophotographic image forming apparatus that forms an image using toner, but not limited thereto. The image forming apparatus 30 may be an inkjet image forming apparatus or the like.

Further, as to the various data (printer information, color management datasets, color management presets, etc.) stored in the storage section 52 of the color management apparatus 50, as long as they are usable by the CPU 51, they may be stored in an external device or the like.

The computer-readable medium that stores the program for executing each process is not limited to the above-described examples. Further, a carrier wave may be applied as a medium that provides data of the program(s) via a communication line.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. A color management method that is performed by a color management apparatus that performs color management based on data of a sheet on which printing has been performed by an image former and that has been read by a reader including a colorimeter and a scanner and disposed on a conveyance path of the sheet, the color management method comprising:
in response to receiving a setting of a first operation mode in which the colorimeter moves a first width in a sheet width direction and reads all or at least one of a plurality of patches arranged in the sheet width direction, performing the color management based on the data read in the first operation mode; and
in response to receiving a setting of a second operation mode in which the colorimeter stops or moves a second width smaller than the first width in the sheet width direction and the scanner reads all or at least one of the plurality of patches arranged in the sheet width direction, performing the color management based on the data read in the second operation mode.

2. The color management method according to claim 1,
wherein the color management apparatus performs the color management based on a color management dataset, and
wherein the color management apparatus
receives a setting of the color management dataset,
obtains a setting of an operation mode indicating either the first operation mode or the second operation mode corresponding to the set color management dataset, and
performs the color management based on the data read in the operation mode indicated by the obtained setting of the operation mode.

3. The color management method according to claim 2,
wherein the color management dataset includes the setting of the operation mode, and
wherein the color management apparatus performs the color management based on the data read in the operation mode indicated by the setting of the operation mode included in the set color management dataset.

4. The color management method according to claim 1, wherein in the first operation mode,
the colorimeter reads the at least one of the plurality of patches arranged in the sheet width direction, and
the scanner reads a rest of the plurality of patches arranged in the sheet width direction not read by the colorimeter.

5. The color management method according to claim 1, wherein in the second operation mode,
the colorimeter stops, and
the scanner reads the all or the at least one of the plurality of patches arranged in the sheet width direction.

6. The color management method according to claim 1, wherein in the second operation mode,
the scanner reads the at least one of the plurality of patches arranged in the sheet width direction, and
the colorimeter reads a rest of the plurality of patches arranged in the sheet width direction not read by the scanner.

7. The color management method according to claim 1, wherein in the second operation mode, the data read by the scanner is corrected based on the data read by the colorimeter.

8. The color management method according to claim 1, wherein the color management is at least one of color verification, creation of a color profile or color correction.

9. The color management method according to claim 1, wherein in response to receiving a setting of an operation mode indicating either the first operation mode or the second operation mode, the color management apparatus presents a processing time related to the color management corresponding to the set operation mode.

10. The color management method according to claim 9, wherein in response to receiving the setting of the first operation mode, the color management apparatus presents the processing time related to the color management.

11. The color management method according to claim 9,
wherein an image printed by the image former is of the patches for the color management, and
wherein the color management apparatus determines the processing time related to the color management in accordance with a number of the patches to be read and/or arrangement of the patches.

12. The color management method according to claim 1, wherein the color management apparatus performs the color management based on the data read in the first operation mode in response to the color management based on the data read in the second operation mode having failed.

13. The color management method according to claim 1, wherein the color management apparatus performs the color management based on the data read in the second operation mode in response to the image former performing the printing on a predetermined number of sheets after the color management apparatus performs the color management based on the data read in the first operation mode.

14. The color management method according to claim 3,
wherein the color management dataset includes a setting of a chart to be used in the color management, and
wherein in registering the color management dataset, the color management apparatus automatically sets, in accordance with the setting of the chart, the operation mode corresponding to the set chart.

15. The color management method according to claim 3,
wherein the color management dataset includes a setting of a color management standard, and
wherein in registering the color management dataset, the color management apparatus automatically sets, in accordance with the setting of the color management standard, the operation mode corresponding to the set color management standard.

16. The color management method according to claim 3,
wherein the color management apparatus is capable of the color management on another image former different from the image former,
wherein a reader disposed on a conveyance path of a sheet on which printing has been performed by the another image former does not have the first operation mode, and
wherein the color management apparatus prohibits the color management dataset including the setting of the first operation mode from being associated with the another image former.

17. The color management method according to claim 3,
wherein the color management apparatus is capable of the color management on another image former different from the image former,
wherein a reader disposed on a conveyance path of a sheet on which printing has been performed by the another image former does not have the first operation mode, and
wherein the color management apparatus automatically changes the setting of the operation mode included in the color management dataset to the second operation mode in response to the color management dataset including the setting of the first operation mode being associated with the another image former.

18. A color management apparatus comprising a hardware processor that performs the color management method according to claim 1.

19. A non-transitory computer-readable storage medium storing a program causing a computer that controls a color management apparatus to perform the color management method according to claim 1.
